(19) United States
(12) Patent Application Publication
(10) Pub. No.: US 2006/0148662 A1
(43) Pub. Date: Jul. 6, 2006

(54) Polyisobutene phosphonic acid and the derivatives thereof

(75) Inventors: Arno Lange, Bad Durkheim (DE); Darijo Mijolovic, Mannheim (DE); Ulrich Karl, Ludwigshafen (DE); Georg Josef Doring, Mannheim (DE); Helmut Witteler, Wachenheim (DE); Ralf Norenberg, Ingelheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/544,475

(22) PCT Filed: Feb. 10, 2004
(86) PCT No.: PCT/EP04/01230

§ 371 Date: Aug. 4, 2005

(30) Foreign Application Priority Data
Feb. 11, 2003 (DE) 103 05 623.8

(51) Int. Cl. C10M 153/02; C10L 1/26; C07F 9/02

(52) U.S. Cl. 508/427; 508/433; 44/375; 558/87; 558/207; 558/214; 562/8; 562/808

(57) ABSTRACT

The present invention relates to polyisobutenephosphonic acids and their derivatives, to a process for preparing them and to their use.

The present invention relates to polyisobutenephosphonic acids and their derivatives, to a process for preparing them and to their use.

Amphiphilic polyalkenyl derivatives which are used for modifying surface properties or the interface behavior, for example as corrosion inhibitors, friction modifiers, emulsifiers or dispersants, are known.

For instance, the International patent application PCT/EP 02/09608 describes a polymer composition which comprises firstly a polyisobutenic component and secondly a different polymer. The polyisobutenic component may be selected from derivatized polyisobutenes. These derivatives are, for example, polyisobutenes which have been epoxidized, hydroformylated, hydroxylated, halogenated, silylated, or functionalized with thio groups or sulfonic acid groups. These compositions are said to have good mechanical properties and/or good interface properties.

U.S. Pat. No. 4,578,178 describes the use of polyalkenylthiophosphonic acids or their esters to prevent the formation of deposits in crude oil or petrochemical products.

U.S. Pat. No. 4,031,017 describes polyisobutene-substituted Mannich adducts in which the polyisobutene radical is phosphosulfurated. The compounds are used as antioxidants and detergents in lubricants.

U.S. Pat. No. 4,778,480 describes polyalkenyl-substituted thiophosphonic acids which are used for color stabilization in diesel fuels. The thiophosphonic acids are obtained by reacting a polyalkene with phosphorus pentasulfide and subsequently hydrolyzing and ethoxylating. Although it is suggested that the thiophosphonic acid might be hydrolyzed in the hydrolysis under certain circumstances even to phosphonic acid, the technical teaching of this document states that the products desired are exclusively sulfur-containing. Moreover, such a hydrolysis product will always contain sulfur in nonnegligible amounts, of which it will generally be very difficult to free.

U.S. Pat. No. 4,244,828 describes a polyalkenylthiophosphonic acid and a polyalkenylphosphonic thioester as an intermediate. Its reaction product is used in lubricant compositions.

A disadvantage of the sulfur-containing phosphonic acids of the four aforementioned US documents is their odor and their color, which make them appear to be unsuitable for certain applications. Moreover, the storage stability and the effectiveness of this compound class is not satisfactory. The use in particular of such sulfur-containing products in fuel oil compositions, such as diesel fuels, gasoline fuels and heating oil, is inconceivable for environmental and political reasons in view of the combustion products of the sulfur present, in particular sulfur dioxide.

It is an object of the present invention to provide novel amphiphilic polyalkenyl derivatives having good application properties. These should in particular be odorless, have sufficient storage stability and/or good surface-active properties.

We have found that this object is achieved by a polyisobutene-phosphonic acid, containing a phosphonic acid radical of the general formula I 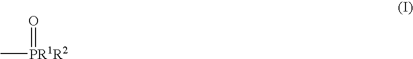
where
R¹ and R² are each independently halogen, OR³, SR³ or NR³R⁴;
R³ and R⁴ are each independently H, C₁-C₂₀-alkyl or C₂-C₄₀₀₀-alkyl which is interrupted by at least one moiety which is selected from O, S and NR¹¹, and R³ and R⁴ together with the nitrogen atom to which they are bonded may also form a ring, and R³ and R⁴ are also aryl, aralkyl or cycloalkyl; and
R¹¹ is as defined for R³ and R⁴,
and salts thereof.

Preferred polyisobutenephosphonic acids contain no thioester groups, i.e. in formula I, R¹ and R² are preferably each independently halogen, OR³ or NR³R⁴, where R³ and R⁴ are each as defined above. Particular preference is given to R³ and R⁴ preferably each independently being H, C₁-C₂₀-alkyl or C₂-C₄₀₀₀-alkyl which is interrupted by at least one moiety which is selected from O and NR¹¹, and R³ and R⁴ together with the nitrogen atom to which they are bonded may also form a ring; R³ and R⁴ are also aryl, aralkyl or cycloalkyl. R¹¹ is as defined for R³ and R⁴. In particular, the R³ and R⁴ radicals also contain no sulfur-containing groups. Preference is also given to salts thereof.

In the context of the present invention, the term “polyisobutene-phosphonic acid” refers both to the phosphonic acid itself and to its derivatives.

In the polyisobutenephosphonic acids according to the invention, the phosphonic acid radical I is preferably bonded to one or more chain ends of the polyisobutene group. In the context of the present invention, the chain ends are in each case the three outer carbon atoms of the polymer framework at each end of the polymer chain. Correspondingly, the phosphonic acid radical I is preferably bonded to one of the three outer carbon atoms of the polymer framework, more preferably to the last carbon atom of the polymer framework. The chain end which bears the phosphonic acid group I may be saturated or unsaturated. The phosphonic acid group is preferably bonded to a carbon atom which is part of a carbon-carbon double bond, and more preferably to the outer carbon atom of a methylidene group. However, it is also possible that the phosphonic acid radical I is bonded to a saturated carbon atom.

A polyisobutenephosphonic acid according to the invention can be illustrated, for example, by the following, nonlimiting structural formula II
A [symbol] M-B)ₙ (II)
where
A is a radical derived from a polymerization initiator,
M is a polymer chain which contains repeating units of the formula [symbol] CH₂—C(CH₃)₂ [symbol] (III),
B is a chain end which bears a phosphonic acid radical of the formula I in covalently bonded form and
n is a number from 1 to 6.

The structure of the terminus B depends, inter alia, on the structure of the polyisobutene from which the polyisobutene-phosphonic acids according to the invention are obtainable, in particular on its chain end. The structure of the chain end is in turn dependent upon the type, the conditions and the termination of the polymerization reaction by which this polyisobutene is prepared. The structure of the terminus B is also determined by the reaction by which the polyisobutenephosphonic acids according to the invention are obtainable from the polyisobutene.

For example, B may be one of the groups a to e, although the structural formulae do not constitute a restrictive list: 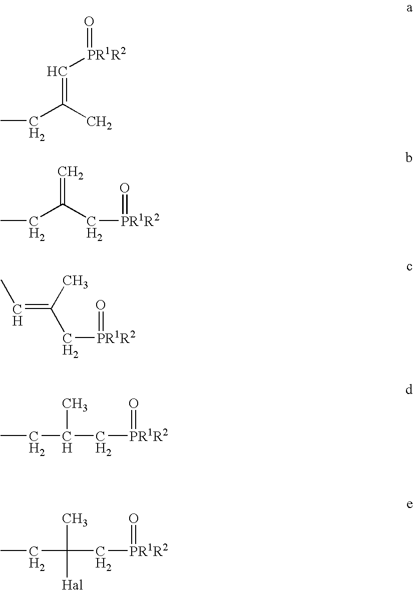
where R¹ and R² are each as defined above and Hal is halogen.

The structure of the start of the chain A also depends on the type of the polymerization by which the parent polyisobutene of the polyisobutenephosphonic acid according to the invention is prepared. If the cationic polymerization is ended hydrolytically, A may be the hydrolysis product of the group which is at the start of the chain and is formed in the course of the polymerization, for example a tert-butyl radical. If the polyisobutene is prepared, for example, under the conditions of a living cationic polymerization in the presence of an initiator molecule (“inifer”), A may also be a radical derived from the initiator molecule. The start of the chain A may also contain a phosphonic acid radical I in covalently bonded form.

n is, for example, a number greater than 1 when the polyisobutene is prepared under the conditions of a living cationic polymerization in the presence of an initiator molecule which is at least bifunctional, i.e. from which at least two polymer chains can result.

In the context of the present invention, C₁-C₂₀-alkyl is a linear or branched alkyl group, such as methyl, ethyl, n-propyl, isopropyl, n-butyl, sec-butyl, isobutyl, tert-butyl, pentyl, hexyl, heptyl, octyl, 2-ethylhexyl, nonyl, decyl, undecyl, dodecyl, tridecyl, tetradecyl, pentadecyl, hexadecyl, heptadecyl, octadecyl, nonadecyl or eicosyl, or else their positional isomers. C₁-C₂₄-Alkyl is additionally heneicosyl, docosyl, tricosyl and tetracosyl, or else their positional isomers. The alkyl radical is optionally substituted by at least one group which is selected from cycloalkyl, halogen, OR⁵, SR⁵ and NR⁵R⁶, where R⁵ and R⁶ are each independently H or C₁-C₆-alkyl. The alkyl radical is preferably not substituted by an SR⁵ radical. This is especially true when the polyisobutenephosphonic acid according to the invention is to be used in fuel and lubricant compositions.

The C₂-C₄₀₀₀ radical which is interrupted by at least one O, S and/or NR¹¹ moiety may also be substituted by at least one group which is selected from cycloalkyl, halogen, OR⁵, SR⁵ and NR⁵R⁶, where R⁵ and R⁶ are each independently H or C₁-C₆-alkyl. The C₂-C₄₀₀₀-alkyl radical is preferably not interrupted by an S moiety. Moreover, it is also preferably not substituted by an SR⁵ radical. This is especially true when the polyisobutene-phosphonic acid according to the invention is to be used in fuel and lubricant compositions.

The C₂-C₄₀₀₀-alkyl radical is preferably a radical of the formula IV [symbol]
(CR⁷R⁸)ₖ(CR⁹R¹⁰)ₘ—X [symbol] ₗ—(CR⁷R⁸)ₖ(CR⁹R¹⁰)ₘ—Y (IV)
where R⁷, R⁸, R⁹ and R¹⁰ are each independently H or C₁-C₄-alkyl,
X is O, S or NR¹¹,
Y is H, OR¹², SR¹² or NR¹²R¹³,
R¹¹ is H or C₁-C₄-alkyl,
R¹² and R¹³ are each independently H or C₁-C₆-alkyl,
k is a number from 1 to 6,
m is a number from 0 to 5, and the sum of k and m is from 1 to 6, and
l is a number from 1 to 1 000.

The alkylene group (CR⁷R⁸)ₖ(CR⁹R¹⁰)ₘ is, for example, 1,2-ethylene, 1,2-propylene, 1,3-propylene, 1,2-butylene, 2,3-butylene or 1,4-butylene. It is preferably 1,2-ethylene or 1,2-propylene, in particular 1,2-ethylene.

k and m are preferably each a number from 1 to 3, especially 1.

The sum of k and m is preferably a number from 2 to 4 and more preferably 2.

l is preferably a number from 1 to 300, more preferably from 1 to 40 and especially from 1 to 4.

In the context of the present invention, C₁-C₄-alkyl is, for example, methyl, ethyl, n-propyl, isopropyl, n-butyl, sec-butyl, isobutyl or tert-butyl; C₁-C₆-alkyl is additionally pentyl, hexyl and their positional isomers.

When two alkyl radicals R³ and R⁴ together with the nitrogen atom to which they are bonded form a ring, this is, for example, a pyrrolidine, piperidine, piperazine or morpholine ring.

Aryl is preferably optionally substituted phenyl or naphthyl. Suitable substituents are, for example, halogen, C₁-C₄-alkyl and C₁-C₄-alkoxy.

Aralkyl is preferably benzyl or 2-phenylethyl.

Cycloalkyl is preferably C₃-C₁₀-cycloalkyl such as cyclopropyl, cyclopentyl, cyclohexyl, cyclooctyl or cyclodecyl, and more preferably C₃-C₆-cycloalkyl. The cycloalkyl radical may be interrupted by at least one moiety which is selected from O, S and NR¹¹, and/or substituted by at least one group which is selected from C₁-C₂₀-alkyl, halogen, OR⁵, SR⁵ and NR⁵R⁶. Cycloalkyl interrupted by at least one O, S and/or NR¹¹ moiety is, for example, pyrrolidyl, tetrahydrofuranyl, tetrahydrothienyl, oxazolidinyl, piperidinyl, piperazinyl or morpholinyl, and it will be appreciated that the cycloalkyl radical must not be bonded via the ring heteroatom to the oxygen, sulfur or nitrogen atom of the R¹ or R² radicals. The cycloalkyl radical is preferably not interrupted by an S moiety. Moreover, it is preferably also not substituted by an SR⁵ radical. This is especially true when the polyisobutenephosphonic acid according to the invention is to be used in fuel and lubricant compositions.

Halogen is preferably Cl or Br and more preferably Cl.

In the salts of the polyisobutenephosphonic acid according to the invention, R¹ and/or R² are a O⁻Mⁿ⁺_{1/n} or S⁻Mⁿ⁺_{1/n} radical, where M is a cation and n is its charge.

Suitable cations are the cations of alkali metals, such as lithium, sodium or potassium, or alkaline earth metals, such as magnesium or calcium, and of heavy metals, such as iron, zinc or silver, and additionally ammonium cations [NR^{a}R^{b}R^{c}R^{d}]⁺ where R^{a} to R^{d} are each independently H, C₁-C₆-alkyl, C₁-C₆-alkoxy or aryl. Preferred cations are alkali metal and alkaline earth metal cations, and also ammonium cations.

In the polyisobutenephosphonic acids according to the invention, R³ and R⁴ are preferably each H. Also, R³ and R⁴ are preferably each optionally substituted C₁-C₁₀-alkyl. In addition, R³ and R⁴ are preferably each a radical of the formula IV in which X is O and Y is OR¹², or in which X is NR¹¹ and Y is NR¹²R¹³, i.e. a polyether or polyamine radical. In particularly preferred radicals IV, R⁷ and R⁹ are each H, and R⁸ and R¹⁰ are each H or C₁-C₄-alkyl, in particular H or methyl, and especially H. k and m are preferably each a number from 1 to 3, in particular 1. The sum of k and m is preferably a number from 2 to 4. l is preferably a number from 1 to 300, more preferably from 1 to 40, in particular from 1 to 10 and especially from 1 to 4.

Preferred polyether radicals are those of the formula IV.a [symbol]
(CH₂)₂—O [symbol] ₗ—(CH₂)₂—OR¹² (IV.a)
where
l is a number from 1 to 1 000, preferably from 1 to 300, more preferably from 1 to 40, in particular from 1 to 10 and especially from 1 to 4, and
R¹² is H or C₁-C₆-alkyl, in particular H, methyl or ethyl.

Preferred radicals IV.a are correspondingly di-, tri-, tetra- or pentaethylene glycol radicals, and also polyethylene glycol radicals having up to 1 000 repeating units. Examples of such higher polyethylene glycol radicals are radicals which derive from the Pluronic, Pluriol and Lutensol brands of BASF AG.

Also suitable as C₂-C₄₀₀₀-alkyl radicals are polyether-containing radicals which derive from block copolymers of alkylene oxides and alkenes as monomers. Suitable alkylene oxides are, for example, ethylene oxide and propylene oxide. Suitable alkenes are, for example, ethylene, propylene and isobutene.

Preferred polyamine radicals are those of the formula IV.b [symbol]
(CH₂)₂—NR¹¹ [symbol] ₗ—(CH₂)₂—NR¹²R¹³ (IV.b)
where
l is a number from 1 to 1 000, more preferably from 1 to 300, in particular from 1 to 40 and especially from 1 to 4,
R¹¹ is H or C₁-C₄-alkyl, preferably H or methyl, and in particular H, and
R¹² and R¹³ are each independently H or C₁-C₆-alkyl, and in particular H.

R¹² and R¹³ are more preferably the same radical.

In preferred NR³R⁴ radicals, R³ and R⁴ are either the same radical, or one of the R³ and R⁴ radicals is H and the other radical is a radical other than H. Preferred radicals other than H are C₁-C₁₀-alkyl which is unsubstituted or substituted by an OR⁵ or NR⁵R⁶ radical, or radicals of the formula IV.b.

In particularly preferred polyisobutenephosphonic acids, the R¹ and R² radicals are each independently halogen, OH, NH₂, OR³ where R³ is C₁-C₂₀-alkyl, NR³R⁴ where R³ is H or C₁-C₂₀-alkyl and R⁴ is C₁-C₂₀-alkyl, or a radical of the formula V.a or V.b
—O [symbol] (CH₂)₂—O [symbol] ₗ—(CH₂)₂—OR¹² (V.a)
—NH [symbol] (CH₂)₂—NH [symbol] ₗ—(CH₂)₂—NR¹²R¹³ (V.b)
where l, R¹² and R¹³ are each as defined for the radicals IV.a and IV.b.

Particularly preferred R¹ and R² radicals are halogen, OH, NH₂, OR³ or NR³R⁴, where R³ is C₁-C₁₀-alkyl, in particular C₁-C₆-alkyl, which is substituted by a radical which is selected from NH₂, dimethylamine, diethylamine, OH, methoxy or ethoxy, and R⁴ is H or is as defined for R³, or they are a radical of the formula V.a or V.b.

Particular preference is also given to the salts of the polyisobutenephosphonic acids according to the invention.

The polyisobutene radical in the polyisobutenephosphonic acid according to the invention preferably has a number-average molecular weight Mₙ of from 100 to 1 000 000, more preferably from 100 to 100 000, in particular from 200 to 60 000 and especially from 200 to 40 000. The choice of polyisobutene radicals having certain molecular weights depends on the application medium and intended application of the particular polyisobutenephosphonic acid according to the invention and is determined by those skilled in the art in the individual case.

Amphiphilic substances generally consist of a polar head group and a lipophilic tail. With a given head group (corresponds substantially to the radical of the formula I), the lipophilicity of the compounds is substantially determined by the tail group (corresponds substantially to the polyisobutene radical). The molecular weight of this group generally correlates with the HLB value (hydrophilic lipophilic balance) of the compound and thus determines its suitability for specific applications for surface modification. The HLB value is a measure of the water and oil solubility of surface-active substances and of the stability of emulsions. Generally, substances having an HLB value of from 3 to 8 are suitable for use in W/O emulsions, those having an HLB value of from 8.5 to 11 in W/O microemulsions, those having an HLB value of from 7 to 9 as wetting agents, those having an HLB value of from 8 to 18 in O/W emulsions, those having an HLB value of from 13 to 15 as detergents and those having an HLB value of from 12 to 18 as solubilizers (cf. Rbmpp Chemie-Lexikon, 9th edition, G. Thieme Verlag, p. 1812 and literature cited therein). The use of the polyisobutenephosphonic acid according to the invention as a corrosion inhibitor for metals or for hydrophobicizing basic surfaces, such as plaster, cement or calcium carbonate, is subject to no strict requirements on the HLB value, so that polyisobutene radicals having a number-average molecular weight of from 500 to 40 000 are suitable here. If the polyisobutenephosphonic acid is to be used as a detergent or a dispersant in fuel and lubricant compositions, narrower HLB ranges are to be observed and accordingly polyisobutene radicals having a number-average molecular weight of from 100 to 3 000 are suitable. This molecular weight range is also suitable for their use as emulsifiers, for example in W/O emulsions, O/W emulsions or microemulsions.

For a given head group, the molecular weight of the tail group also generally correlates with the viscosity. In general, a relatively high molecular weight of a polymer within a polymer homolog series results in a relatively high viscosity of the solution which contains it (cf. Römpp Chemie-Lexikon, 9th edition, G. Thieme Verlag, p. 4939 and literature cited therein). Accordingly, for applications in which a low miscibility or processibility of the polyisobutenephosphonic acid according to the invention with the application medium is desired and therefore a low viscosity, for example in certain applications of the polyisobutenephosphonic acid according to the invention in the printing sector, in lubricant compositions, as a plastics additive or in monolayers for hydrophobicizing of the coated material, polyisobutene radicals are selected which have relatively low molecular weights, in particular having an Mₙ of from 100 to 10 000, preferably from 100 to 1000. When a moderate viscosity is desired, for example in certain applications of the polyisobutenephosphonic acid according to the invention in emulsions, dispersions or for hydrophobicizing of basic inorganic material, such as plaster, cement or calcium carbonate, polyisobutene radicals especially are selected which have an Mₙ of from 500 to 60 000, preferably from >1000 to 50 000, for example from >1000 to 10 000. When high viscosities of the application medium are desired, especially suitable polyisobutene radicals have an Mₙ Of from 2300 to 1 000 000, preferably from >10 000 to 100 000. With regard to further features of suitable and preferred polyisobutene radicals, reference is made to the remarks hereinbelow.

The polyisobutenephosphonic acid according to the invention is obtainable by customary prior art processes for preparing organic phosphonic acid derivatives. Such processes are described, for example, in Houben-Weyl, Methoden der organischen Chemie [Methods of organic chemistry], 4th edition, volume XII/1, pages 338 to 619 (1963) and in volume E 2, pages 300 to 418 (1982). These extracts and the literature cited therein are fully incorporated herein by way of reference.

The present invention further provides a process for preparing a polyisobutenephosphonic acid according to the invention, by
a) reacting a polyisobutene with a phosphorus pentahalide and either
b1) reacting the reaction product obtained in step a) with a halogen scavenger and
c1) optionally reacting the reaction product obtained in step b1) with water, at least one alcohol, at least one thiol and/or at least one amine, or
b2) reacting the reaction product obtained in step a) with water, at least one alcohol, at least one thiol and/or at least one amine.

Preference is given to using no thiol in the reaction in step c1) or b2).

Preferred phosphorus pentahalides are phosphorus(V) chloride and phosphorus(V) bromide, and particular preference is given to phosphorus(V) chloride.

In step a), the phosphorus pentahalides can be used as such in the reaction. However, if the conversion is to be effected under comparatively mild conditions, phosphorus(V) chloride in particular can be prepared in situ from phosphorus(III) chloride and chlorine. To this end, for example, the polyisobutene and phosphorus(III) chloride are initially charged and chlorine gas is introduced to gradually form phosphorus(V) chloride.

The polyisobutene used may be any common and commercially available polyisobutene.

In the context of the present invention, the term “polyisobutene” also includes oligomeric isobutenes such as dimeric, trimeric or tetrameric isobutene.

In the context of the present invention, polyisobutenes also include all polymers obtainable by cationic polymerization which contain preferably at least 60% by weight of isobutene, more preferably at least 80% by weight, even more preferably at least 90% by weight and in particular at least 95% by weight, of isobutene in copolymerized form. In addition, the polyisobutenes may contain further butene isomers such as 1- or 2-butene, and also different olefinically unsaturated monomers which are copolymerizable with isobutene under cationic polymerization conditions, in copolymerized form.

Suitable isobutene feedstocks for the preparation of polyisobutenes which are suitable as reactants for the process according to the invention are accordingly both isobutene itself and isobutenic C₄ hydrocarbon streams, for example C₄ raffinates, C₄ cuts from isobutane dehydrogenation, C₄ cuts from steam crackers, FCC crackers (FCC: fluid catalyzed cracking), as long as they have been substantially freed of 1,3-butadiene present therein. Particularly suitable C₄ hydrocarbon streams generally contain less than 500 ppm, preferably less than 200 ppm, of butadiene. When C₄ cuts are used as a starting material, the hydrocarbons other than isobutene assume the role of an inert solvent.

Useful copolymerizable monomers are vinylaromatics such as styrene and α-methylstyrene, C₁-C₄-alkylstyrenes such as 2-, 3- and 4-methylstyrene, and also 4-tert-butylstyrene, isoolefins having from 5 to 10 carbon atoms such as 2-methylbutene-1, 2-methylpentene-1, 2-methylhexene-1, 2-ethylpentene-1, 2-ethylhexene-1 and 2-propylheptene-1. Useful comonomers are also olefins which have a silyl group, such as 1-trimethoxysilylethene, 1-(trimethoxysilyl)propene, 1-(trimethoxysilyl)-2-methyl-propene-2, 1-[tri(methoxyethoxy)silyl]ethene, 1-[tri(methoxy-ethoxy)silyl]propene, and 1-[tri(methoxyethoxy)silyl]-2-methyl-propene-2.

Suitable polyisobutenes are all polyisobutenes obtainable by common cationic or living cationic polymerization. However, preference is given to what are known as “reactive” polyisobutenes which differ from low-reactivity polyisobutenes by the content of terminal double bonds. Reactive polyisobutenes differ from low-reactivity polyisobutenes in that they have at least 50 mol %, based on the total number of polyisobutene macromolecules, of terminal double bonds. The reactive polyisobutenes preferably have at least 60 mol % and more preferably at least 80 mol %, based on the total number of polyisobutene macromolecules, of terminal double bonds. The terminal double bonds may be either vinyl double bonds [—CH═C(CH₃)₂](β-olefins) or vinylidene double bonds [(—CH₂—C(═CH₂)—CH₃](α-olefins). Preferred reactive polyisobutenes are those in which at least 60 mol %, more preferably at least 70 mol % and in particular at least 75 mol %, based on the total number of polyisobutene macromolecules, of the terminal double bonds are vinylidene double bonds (α-olefins). However, polyisobutenes having a terminal vinyl double bond (β-olefins) are also suitable.

Suitable polyisobutenes are, for example, the Glissopal brands of BASF AG, for example Glissopal 550, Glissopal 100 and Glissopal 2300, and also the Oppanol brands of BASF AG, such as Oppanol B10, B12, B15, B7 and BV.

Processes for preparing suitable polyisobutenes are known, for example, from DE-A 27 02 604, EP-A 145 235, EP-A 481 297, EP-A 671 419, EP-A 628 575, EP-A 807 641 and WO 99/31151. Polyisobutenes which are prepared by living cationic polymerization of isobutenes or isobutenic monomer mixtures are described, for example, in U.S. Pat. No. 4,946,899, U.S. Pat. No. 4,327,201, U.S. Pat. No. 5,169,914, EP-A 206 756, EP-A 265 053, WO 02/48216 and in J. P. Kennedy, B. Ivan, “Designed Polymers by Carbocationic Macromolecular Engineering”, Oxford University Press, New York 1991. These and other publications which describe polyisobutenes are fully incorporated herein by way of reference.

Depending on the polymerization process, the polydispersity index PDI (=M_{w}/Mₙ) of the resulting polyisobutenes is from about 1.05 to 10. Polymers from living cationic polymerization generally have a PDI of from about 1.05 to 2.0. The molecular weight distribution of the polyisobutenes used in the process according to the invention has a direct effect on the molecular weight distribution of the polyisobutenephosphonic acid according to the invention. Depending on the application of the phosphonic acid according to the invention, polyisobutenes are selected which have a low, a moderate or a broad molecular weight distribution. In general, the PDI value of a compound or of a radical at a given Mₙ correlates with its viscosity. Accordingly, for applications in which easy miscibility or processibility with the application medium and therefore a low viscosity is required, a polyisobutene radical is selected which has a PDI of preferably ≦3.0. In contrast, for surface modifications in the form of coatings, a relatively high viscosity is frequently desired, so that preference is given in this case to polyisobutene radicals having a PDI in the range from 1.5 to 10. Polyisobutenephosphonic acid derivatives having a narrow molecular weight distribution (PDI from about 1.05 to about 2.0) of the polyisobutene radical are suitable, for example, for use as detergents and dispersants in fuel and lubricant compositions, as an additive in pressure systems, in polymers or in monolayers for hydrophobicization. Polymers having a moderate molecular weight distribution (PDI from about 1.6 to about 2.5) are suitable, for example, for use in certain emulsions or dispersions, and also for hydrophobicizing basic materials such as calcium carbonate (for example in the form of mortar), plaster or cement, whereas those having a broad molecular weight distribution (PDI from about 2.1 to about 10) are suitable for use as corrosion inhibitors or likewise for hydrophobicizing basic materials.

The polyisobutene is preferably reacted with the phosphorus pentahalide in a suitable solvent. Suitable solvents are aprotic solvents which behave inertly under the given reaction conditions and in which the reactants are at least partially soluble. These include aliphatic hydrocarbons such as pentane, hexane, heptane, octane, cyclohexane and cyclooctane, aromatic hydrocarbons such as benzene, toluene and the xylenes, chlorinated hydrocarbons such as chloromethane, methylene chloride, chloroform, tetrachloromethane, di- and trichloroethane and chlorobenzene, ethers such as diethyl ether, dipropyl ether and tert-butyl methyl ether, cyclic ethers such as tetrahydrofuran and dioxane, ketones such as acetone and ethyl methyl ketone, dimethyl sulfoxide, dimethylformamide, CS₂ and phosphorus(III) chloride, and also mixtures of these solvents.

The reaction is preferably effected at a temperature of from −20° C. to the boiling point of the solvent, more preferably from 0° C. to 100° C. and in particular from 10° C. to 80° C.

The process according to the invention is suitable preferably for polyisobutenes having terminal vinyl or vinylidene double bonds (α-olefin) as the reactant, which are readily attacked by phosphorus(V) halides. However, under more severe reaction conditions, it is quite possible to react polyisobutenes having β-double bonds (β-olefin) or even with saturated end groups.

The polyisobutene and the phosphorus pentahalide generally react to initially give polyisobuteneorthophosphonic tetrahalides. The orthophosphonic tetrahalide is generally hydrolysis-sensitive and its purification and isolation is correspondingly costly and inconvenient.

In a first preferred embodiment of the process according to the invention, the product of the reaction of polyisobutene and phosphorus pentahalide is therefore reacted with a suitable halogen scavenger (step b1)).

In the context of the present invention, halogen scavengers are those compounds which react with orthophosphonic tetrahalides to give phosphonic dihalides, i.e. to give those polyisobutene-phosphonic acids according to the invention in which R¹ and R² in the phosphonic acid radical I are each halogen.

Preferred halogen scavengers are water, inorganic bases, alcohols, carboxylic acids, carboxylic anhydrides, phosphonic acid, phosphorus pentoxide and sulfur dioxide.

When water is used as the halogen scavenger, it is preferably added in stoichiometric amounts based on the conversion of orthophosphonic tetrahalide to phosphonic dihalide, and the conversion is carried out at very low temperatures and with very short reaction times, in order to stop the reaction at the stage of the phosphonic dihalide. The reaction temperature is preferably from about 0 to 10° C. Particular preference is given to using ice-water. The reaction time depends, inter alia, on the batch size and has to be estimated by those skilled in the art in the individual case. In contrast, a relatively long reaction time, in particular with simultaneous heating, frequently leads to the free polyisobutenephosphonic acid (R¹, R²═OH) as the reaction product.

When the halogen scavenger used is an alcohol, it is likewise used in preferably stoichiometric amounts, based on the conversion of orthophosphonic tetrahalide to phosphonic dihalide. In this case also, the conversion is effected at preferably low temperatures, i.e. at temperatures in the range from −20° C. to 40° C., more preferably from −10° C. to room temperature, and with relatively short reaction times. In contrast, a relatively long reaction time, especially when the alcohols are used in excess and/or with simultaneous heating, frequently leads to the formation of polyisobutenephosphonic monohalide monoesters (R¹=halogen; R²═OR³ where R³ does not equal H) or polyisobutenephosphonic diesters (R¹ and R²═OR³ where R³ does not equal H).

Suitable alcohols are those having from 1 to 10 carbon atoms and from 1 to 4 hydroxyl groups, such as methanol, ethanol, propanol, isopropanol, butanol, isobutanol, tert-butanol, pentanol, hexanol, cyclohexanol, heptanol, octanol, 2-ethylhexanol, nonanol, decanol and their positional isomers, and also ethylene glycol, 1,3-propylene glycol, 1,4-butylene glycol, glycerol, trimethylolpropane and pentaerythritol. Also suitable are polyetherpolyols of the formula VI.a
HO [symbol] (CR⁷R⁸)ₖ(CR⁹R¹⁰)ₘ—O [symbol] ₗ(CR⁷R⁸)ₖ(CR⁹R¹⁰)ₘ—OR¹² (VI.a)
where R⁷ to R¹⁰, R¹², k, l and m are each as defined in formula IV. R⁷ and R⁹ are preferably each H, and R⁸ and R¹⁰ are each H or C₁-C₄-alkyl, in particular H or methyl and especially H. k and m are preferably a number from 1 to 3 and in particular l.

l is preferably a number from 1 to 300, more preferably from 1 to 40, in particular from 1 to 10 and especially from 1 to 4. Particularly preferred polyetherpolyols are di-, tri-, tetra- and pentaethylene glycol (m, k=1, l=1 to 4, R⁷ to R¹⁰ and R¹²═H) and their monomethyl or monoethyl ethers (R¹² =methyl or ethyl), and also higher polyethylene glycols having up to 1 000 repeating units or their monomethyl or ethyl ethers. Examples thereof are the Pluronic, Pluriol or Lutensol brands of BASF AG.

The reaction of the orthophosphonic tetrahalides with carboxylic acids or carboxylic anhydrides generally leads initially only as far as the stage of the phosphonic dihalides. However, the dihalides can also be further reacted with lower fatty acids, for example with C₂-C₁o-carboxylic acids, to give the free phosphonic acids. In contrast, the reaction with carboxylic anhydrides generally stops at the stage of the phosphonic dihalides.

Suitable carboxylic acids are mono- and dicarboxylic acids having from 1 to 10 carbon atoms, such as formic acid, acetic acid, propionic acid, butyric acid, valeric acid, caproic acid, oenanthic acid, caprylic acid, pelargonic acid, capric acid, oxalic acid, malonic acid and succinic acid. Suitable carboxylic anhydrides are the anhydrides of the aforementioned carboxylic acids, for example acetic anhydride, propionic anhydride and succinic anhydride, and preference is given to acetic anhydride.

The reaction of the orthophosphonic tetrahalide with a halogen scavenger, which is selected from sulfur dioxide, phosphorus pentoxide and a polyisobutene phosphonic acid whose polyisobutene radical corresponds to the polyisobuteneorthophosphonic tetrahalide, leads substantially only to the phosphonic dihalide with simultaneous formation of thionyl halide (from sulfur dioxide), phosphorus oxyhalide (from phosphorus pentoxide) or a hydrogen halide (in the case of halogen exchange between orthophosphonic tetrahalide and phosphonic acid). The corresponding chlorides especially, i.e. thionyl chloride, phosphorus oxychloride and hydrogen chloride, can be removed from the mixture, for example by distillation, in the course of their formation, which allows the reaction equilibrium to be advantageously influenced.

The reaction of polyisobuteneorthophosphonic tetrahalide with a halogen scavenger is preferably carried out only to the stage of the phosphonic dihalide. Accordingly, preferred halogen scavengers are carboxylic anhydrides, in particular acetic anhydride, sulfur dioxide, phosphorus pentoxide and the polyisobutenephosphonic acid whose polyisobutene radical corresponds to the polyisobuteneorthophosphonic tetrahalide. When these halogen. scavengers are used, preference is given to continuously removing the products formed from the halogen scavengers, i.e. the acyl halide, the thionyl halide, the phosphorus oxyhalide or the hydrogen halide in the course of the reaction, for example by distillation, and thus advantageously influencing the reaction equilibrium. In particular, sulfur dioxide or a carboxylic anhydride, especially sulfur dioxide or acetic anhydride, are used.

When the halogen scavenger used is a carboxylic anhydride, sulfur dioxide or phosphorus pentoxide, the molar ratio of orthophosphonic tetrahalide to halogen scavenger is preferably from 1:1 to 1:10, more preferably from 1:1 to 1:5 and in particular from 1:1 to 1:3.

When the halogen scavenger used is a polyisobutenephosphonic acid whose polyisobutene radical corresponds to the polyisobuteneorthophosphonic tetrahalide, the molar ratio of orthophosphonic tetrahalide to halogen scavenger is preferably from 1:1 to 1:10, more preferably from 1:1 to 1:5 and in particular from 1:1 to 1:2.

The aforementioned halogen scavengers may also be used in a mixture.

To react the polyisobuteneorthophosphonic tetrahalide with the halogen scavenger, the reaction mixture from the reaction of the polyisobutene with the phosphorus pentahalide, preferably without purifying or isolating the orthophosphonic tetrahalide formed, is admixed with the halogen scavenger, and is added gradually or in one portion. Preference is given to gradual addition. The halogen scavenger may be added and reacted at the same temperature as the preparation of the orthophosphonic tetrahalide, in which case the addition/reaction temperature depends on the particular halogen scavenger. Accordingly, the addition and reaction with water or alcohols are preferably effected at relatively low temperatures, in the case of water preferably in a temperature range of from about 0 to 10° C., and, in the case of the alcohol, preferably in a temperature range of from −20° C. to 40° C., if the reaction is to be stopped at the stage of the phosphonic dihalide. When carboxylic anhydrides, sulfur dioxide, phosphorus pentoxide or the corresponding polyisobutenephosphonic acid are used, a higher addition and/or reaction temperature may be selected, for example in the range from 0° C. to the boiling point of the solvent used, preferably from room temperature to the boiling point of the solvent, more preferably from room temperature to 100° C. and in particular from room temperature to 80° C.

The reaction mixture may subsequently be worked up by customary processes. For example, excess halogen scavengers or their reaction products which have not yet been removed in the course of the reaction can be removed by distillation or extraction, as can any solvent used. The polyisobutenephosphonic dihalide formed and any other phosphonic acid derivatives which might have been formed are purified, for example, by digestion, extraction or filtering and optionally drying, for example with sodium sulfate or magnesium sulfate.

The reaction products of the polyisobuteneorthophosphonic tetrahalides obtained by the reaction with the halogen scavenger, in particular the phosphonic dihalides, but also any monoalkyl monohalophosphonates, dialkyl phosphonates or free phosphonic acid formed, are subsequently further derivatized if desired by reacting with water, at least one alcohol, at least one thiol and/or at least one amine (step c1)).

Depending on the molar ratio of the reactants and depending on the reaction conditions, the reaction of polyisobutenephosphonic dihalides with alcohols leads to different products. For instance, the reaction of phosphonic dihalides with an alcohol without simultaneous removal of the hydrogen halide formed leads frequently to phosphonic monoesters. In contrast, when the phosphonic dihalide is reacted with an alkoxide or when the alcohol is converted in the presence of a tertiary amine, the corresponding phosphonic monohalide monoester is obtained, especially when alcohol or alkoxide are used in deficiency. When the phosphonic dihalide is reacted with an alcohol in excess and the hydrogen halide released is removed simultaneously or bound with a suitable acid scavenger, the corresponding phosphonic diesters are generally formed.

If mixed phosphonic diesters, i.e. diesters of different alcohols, are to be formed, preference is given to initially preparing either a phosphonic monoester or a phosphonic monohalide monoester by reacting with a first alcohol and then reacting it in a subsequent reaction with a second alcohol to give the diester. It is also possible to partially transesterify a diester formed with a first alcohol by reacting with a second alcohol.

Suitable alcohols are the alcohols listed as halogen scavengers, and also alcohols having from 11 to 20 carbon atoms and from 1 to 4, preferably from 1 to 2, hydroxyl groups, and in particular 1 hydroxyl group. Examples thereof are undecanol, dodecanol, tridecanol, tetradecanol, pentadecanol, hexadecanol, heptadecanol, octadecanol, nonadecanol and eicosyl alcohol and also their positional isomers. The remarks made for the halogen scavengers with regard to preferred alcohols apply here correspondingly, and particular preference is given to polyetherpolyols of the formula VI.a. Preference is given in particular to polyetherpolyols in which R⁷ and R⁹ are each H and R⁸ and R¹⁰ are each H or C₁-C₄-alkyl, in particular H or methyl and especially H, k and m are a number from 1 to 3, in particular 1, l is a number from 1 to 300, more preferably from 1 to 40, in particular from 1 to 10 and especially from 1 to 4, and R¹² is H, methyl or ethyl, and especially methyl.

Also suitable are amino alcohols having from 2 to 20 carbon atoms, from 1 to 3 amino groups and from 1 to 3 hydroxyl groups. The amino alcohols preferably contain one hydroxyl group and one amino group. The amino group is preferably a tertiary amino group. Examples of suitable amino alcohols are 2-aminoethanol, 2-N,N-dimethyl- and 2-N,N-diethylaminoethanol, 3-aminopropanol, 3-N,N-dimethyl- and 3-N,N-diethylaminopropanol and the higher homologs thereof.

Also suitable are mercapto alcohols, in particular those in which the thio group is present in etherified form. Examples of suitable mercapto alcohols are 2-mercaptoethanol, 2-(methylmercapto)ethanol, 2-(ethylmercapto)ethanol, 3-mercapto-1-propanol, 3-mercapto-2-propanol, 3-(methylmercapto)-1-propanol, 3-(methylmercapto)-2-propanol, 3-(ethylmercapto)-1-propanol, 3-(ethylmercapto)-2-propanol, bis(2-hydroxyethyl) sulfide and the like.

However, preference is given to using no mercapto alcohols.

Also suitable are aromatic hydroxyl compounds, such as optionally substituted phenols, naphthols or benzyl alcohols. Suitable substituted aromatic alcohols are those which bear from 1 to 3 substituents which are selected from halogen, C₁-C₆-alkyl and C₁-C₆-alkoxy.

Instead of the alcohols, the corresponding alkoxides can also be used. Suitable alkoxides are the corresponding alkali metal, alkaline earth metal, heavy metal and ammonium alkoxides, and preference is given to the alkali metal alkoxides, in particular the sodium or potassium alkoxides, and also the ammonium alkoxides.

Suitable tertiary amines are aliphatic amines such as triethylamine, tripropylamine or ethyldiisopropylamine, aromatic amines such as N,N-dimethylaniline, and heterocyclic amines such as pyrrole, pyridine, 2,6-dimethylpyridine, 2,6-tert-butyl-pyridine, quinoline, DBU and DBN.

Suitable acid scavengers are in particular the aforementioned tertiary amines, and additionally secondary amines such as diethylamine, dipropylamine, diisopropylamine, N-methylaniline and piperidine, and also inorganic bases such as alkali metal and alkaline earth metal hydroxides, alkali metal hydrogencarbonates and alkali metal carbonates. If pure monoesters, monoester monohalides or diesters are to be obtained, preference is given to not using secondary amines as acid scavengers, since they can react under the given reaction conditions with the phosphonic acid derivatives, in particular with the phosphonic dihalide, phosphonic monoester monohalide or phosphonic monoester to give, for example, the phosphonic monoester monoamide and other reaction products.

The reaction is preferably effected in a suitable solvent. Suitable solvents are aprotic solvents, for example aliphatic hydrocarbons such as pentane, hexane, heptane, octane, cyclohexane or cyclooctane, chlorinated aliphatic hydrocarbons such as methylene chloride, chloroform, carbon tetrachloride, di- or trichloroethane, aromatic hydrocarbons such as benzene, toluene, xylene, nitrobenzene or chlorobenzene, ethers such as diethyl ether, dipropyl ether, diisopropyl ether or tert-butyl methyl ether, cyclic ethers such as tetrahydrofuran or dioxane, ketones such as acetone or methyl ethyl ketone, carboxylic acid derivatives such as ethyl acetate, methyl acetate or N,N-dimethylformamide, dimethyl sulfoxide or mixtures of these solvents. Preferred solvents are aliphatic hydrocarbons, in particular hexane, chlorinated aliphatic hydrocarbons, in particular methylene chloride and chloroform, aromatic hydrocarbons, in particular toluene, and cyclic ethers, in particular tetrahydrofuran, and also their mixtures. However, suitable solvents are also the alcohols themselves, as long as they are liquid under the given reaction conditions and can be removed on completion of reaction. Also suitable are mixtures of such alcohols with the aforementioned solvents.

The reaction of the phosphonic dihalides with the alcohol is effected preferably at a temperature of from −10° C. to the boiling point of the reaction mixture, more preferably from −10° C. to 30° C.

The molar ratio of phosphonic dihalide to the alcohol used depends on whether a monoester, a diester or a mixed diester is to be prepared. If a monoester or a mixed diester are to be prepared dihalide and alcohol are used in a molar ratio of preferably from 1:0.8 to 1.5, more preferably from 1:0.8 to 1.2 and in particular of about 1:1. If diesters of the same alcohols are to be prepared, the molar ratio of dihalide to alcohol is preferably from 1:1.8 to 3, more preferably from 1:1.8 to 2.5 and in particular about 1:2.

The reaction of the phosphonic dihalide with the alcohol is preferably effected in such a way, for example, that the dihalide and optionally the tertiary amine or a different acid scavenger are initially charged in a solvent and subsequently admixed with the alcohol. On completion of reaction, the reaction mixture is worked up by customary processes, for example by distillative or extractive removal of the solvent, any excess alcohol and/or acid scavenger, optionally after filtering, from its reaction products.

Phosphonic dihalides can also be reacted with an alcohol and an amine to give phosphonic monoester monoamides by, for example, initially reacting the dihalide with the alcohol as described above to give the phosphonic monoester monohalide, or optionally further to give the phosphonic monoester, and reacting the monoester halide or the monoester with the amine, or, conversely, initially reacting the dihalide with the amine as described below to give the phosphonic monoamide monohalide or optionally further to give the phosphonic monoamide, and subsequently converting the reaction product using the alcohol to the phosphonic monoester monoamide. Alternatively, the dihalide may also be reacted with a mixture of alcohol and amine. With regard to suitable and preferred alcohols, amines, reactant ratios and reaction conditions, reference is made to the remarks which have already been made and to those made below with regard to the amines.

In a similar manner, phosphonic dihalides can be converted using an alcohol and a thiol to mixed phosphonic (O,S)-diesters. With regard to suitable and preferred thiols, reference is made to the remarks which follow. However, preference is given to using no thiols.

The reaction of polyisobutenephosphonic dihalides with two equivalents of a secondary amine or the hydrochloride of a primary aromatic ammonium salt generally leads to the corresponding polyisobutenephosphonic monohalide monoamide. In contrast, the reaction with four equivalents of a secondary amine leads generally to the corresponding phosphonic diamide. The use of primary amines or of ammonia leads frequently also to the formation of phosphonimides; however, imide formation can generally be prevented by using the amine or the ammonia in excess. Mixed amides, i.e. amides of two different amines, are obtained, for example, by reacting the polyisobutenephosphonic dihalide first with a first amine to give the corresponding polyisobutenephosphonic monohalide monoamide and then reacting it with a second amine to give the mixed diamide.

Suitable primary amines are both mono- and polyamines having from 1 to 20 carbon atoms. Primary amines are amines NR^{a}R^{b}^{c}, in which two of the R^{a}, R^{b} or R^{c} radicals are H.

Examples of suitable primary monoamines are methylamine, ethylamine, propylamine, butylamine, pentylamine, hexylamine, heptylamine, octylamine, 2-ethylhexylamine, nonylamine, decylamine, undecylamine, dodecylamine, tridecylamine, tetradecylamine, pentadecylamine, hexadecylamine, heptadecylamine, octadecylamine, nonadecylamine, eicosylamine and also cyclooctylamine and cyclodecylamine.

Also suitable are hydroxy- or alkoxy-substituted amines, such as 2-hydroxyethylamine, 2-methoxyethylamine, 2-ethoxyethylamine, 3-hydroxypropylamine, 3-methoxypropylamine and 3-ethoxypropylamine and the like.

Preferred primary monoamines are ethylamine, butylamine, 2-ethylhexylamine and 2-hydroxyethylamine.

Also suitable are primary aromatic amines such as aniline.

Suitable primary polyamines are those of the formula VI.b
H₂N [symbol] (CR⁷R⁸)ₖ(CR⁹R¹⁰)ₘ—NR¹¹ [symbol] ₗ[(CR⁷R⁸)ₖ(CR⁹R¹⁰)ₘ—NR¹²R¹³ (VI.b)
where R⁷ to R¹³ and also k and m are each as defined in formula IV and 1 is a number from 0 to 1 000.

R⁷ and R⁹ are preferably each H. R⁸ and R¹⁰ are preferably each H or C₁-C₄-alkyl, in particular H or methyl and especially H. R¹¹ is preferably H. k and m are preferably each a number from 1 to 3, in particular 1. l is preferably a number from 0 to 300, more preferably from 0 to 40, in particular from 0 to 10 and especially from 0 to 4. R¹² and R¹³ are preferably each H. Particularly preferred primary polyamines are ethylenediamine, diethylenetriamine, triethylenetetramine, tetraethylenepentamine and pentaethylenehexamine, and also 3-N,N-dimethylaminopropylamine and 3-N,N-diethylaminopropylamine.

Suitable secondary amines are both mono- and polyamines having from 1 to 20 carbon atoms. Secondary amines are amines NR^{a}R^{b}R^{c}, in which only one of the R^{a}, R^{b} or R^{c} radicals is H.

Suitable secondary monoamines are, for example, dimethylamine, diethylamine, dipropylamine, diisopropylamine, dibutylamine, diisobutylamine, di-tert-butylamine, dipentylamine, dihexylamine, diheptylamine, dioctylamine, di(2-ethylhexyl)amine, dinonylamine and didecylamine, and also N-methylcyclohexylamine, N-ethylcyclohexylamine and dicyclohexylamine, and also piperidine, piperazine and morpholine. Preferred secondary monoamines are dimethylamine, diethylamine, dipropylamine, diisopropylamine, dibutylamine, dipentylamine, dihexylamine and di(2-ethylhexyl)amine.

Also suitable are hydroxy- or alkoxy-substituted amines, such as bis(2-hydroxyethyl)amine, bis(2-methoxy- ethyl)amine and bis(2-ethoxyethyl)amine.

Also suitable are secondary aromatic amines, such as N-methylaniline or diphenylamine.

Suitable secondary polyamines are those of the formula
NHR¹⁴R¹⁵
where
R¹⁴ is a radical of the formula VII [symbol]
   (CR⁷R⁸)ₖ(CR⁹R¹⁰)ₘ—NR¹¹ [symbol] ₗ(CR⁷R⁸)ₖ(CR⁹R¹⁰)ₘ—NR¹²R¹³ (VII)
   where
R⁷ to R¹¹ and also k and m are as defined in formula IV,
R¹² is H or C₁-C₆-alkyl,
R¹³ is C₁-C₆-alkyl and
l is a number from 0 to 1 000 and
R¹⁵ is C₁-C₆-alkyl or a radical of the formula VII.

R⁷ and R⁹ are preferably each H. R⁸ and R¹⁰ are preferably each H or C₁-C₄-alkyl, in particular H or methyl and especially H. R¹¹ is preferably H. k and m are preferably each a number from 1 to 3, in particular 1. l is preferably a number from 0 to 300, more preferably from 0 to 40, in particular from 0 to 10 and especially from 0 to 4. R¹⁵ is preferably a radical of the formula VII.

Particularly preferred secondary amines are diethylamine, diisopropylamine, bis(2-hydroxyethyl)amine and bis(3-N′,N′-dimethylaminopropyl)amine.

Preference is given to using primary amines in the process according to the invention, in particular primary polyamines.

The reaction is preferably carried out in a suitable solvent. Suitable and preferred solvents are the solvents specified for the reaction of phosphonic dihalide with an alcohol, apart from the alcohols.

The reaction is preferably effected at a temperature of from 0° C. to the boiling point of the reaction mixture, more preferably from 0° C. to 50° C.

The molar ratio of phosphonic dihalide to amine is dependent upon the desired reaction product, and also on the type of the amine. If a phosphonic monohalide monoamide is to be prepared, the molar ratio of dihalide to secondary amine is preferably from 1:1.6 to 3, more preferably from 1:1.6 to 2.4 and in particular about 1:2. The molar ratio of dihalide to primary amine is preferably from 1:1.6 to 3, more preferably from 1:1.6 to 2.4. If a diamide is to be prepared, the molar ratio of dihalide to secondary amine is preferably from 1:1.8 to 6, more preferably from 1:1.8 to 5 and in particular about 1:4. The molar ratio of dihalide to primary amine is preferably from 1:1.8 to 6, more preferably from 1:1.8 to 5.

The phosphonic dihalide is reacted with an amine, for example, in such a way that the dihalide is initially charged in a solvent and the mixture is subsequently admixed with the amine. On completion of reaction, the reaction mixture is worked up by customary processes, for example by distillative or extractive removal of the solvent and of any excess amine, and also filtering of ammonium salts formed.

The reaction of phosphonic dihalides with a mixture of an alcohol and an amine generally results in the corresponding phosphonic onoester monoamide.

Depending on the stoichiometry, the reaction of polyisobutene-phosphonic dihalides with thiols in the presence of acid scavengers leads either to phosphonic monohalide monothioesters or to the corresponding dithioesters.

Suitable thiols are those having from 1 to 20 carbon atoms, such as methyl thiol, ethyl thiol, propyl thiol, butyl thiol, pentyl thiol, hexyl thiol, heptyl thiol, octyl thiol, nonyl thiol or decyl thiol, and also the higher homologs and positional isomers. Also suitable are polythioether polythiols of the formula VI.c
HS [symbol] (CR⁷R⁸)ₖ(CR⁹R¹⁰)ₘ—S [symbol] ₗ(CR⁷R⁸)ₖ(CR⁹R¹⁰)ₘ—SR¹² (VI.C)
where R⁷ to R¹² and also k, l and m are each as defined in formula IV.

R⁷ and R⁹ are preferably each H. R⁸ and R¹⁰ are preferably each H or C₁-C₄-alkyl, in particular H or methyl and especially H. k and are preferably each a number from 1 to 3, in particular 1. l is preferably a number from 1 to 300, more preferably from 1 to 40, in particular from 1 to 10 and especially from 1 to 4. Suitable polythioether polythiols are both dithiols (R¹²═H) and their monothioethers (R¹²′C₁-C₆-alkyl).

Also suitable are aromatic thiols, for example thiophenol itself and also thiophenols which bear from 1 to 3 substituents selected from halogen, C₁-C₆-alkyl and C₁-C₆-alkoxy.

Also suitable are polysulfides HS—Sₓ—SH where x=from 1 to 10.

Preference is given to carrying out the reaction in a suitable solvent. Suitable and preferred solvents are the solvents specified for the reaction of phosphonic dihalide with an alcohol, apart from the alcohols.

The reaction is preferably effected at a temperature of from −20° C. to the boiling point of the reaction mixture, more preferably from 0° C. to 50° C.

The molar ratio of phosphonic dihalide to thiol used depends upon whether a monothioester, a dithioester or a mixed dithioester is to be prepared. If a monothioester or a mixed dithioester are to be prepared, dihalide and thiol are used in a molar ratio of preferably from 1:0.8 to 1.5, more preferably from 1:0.8 to 1.2 and in particular of about 1:1. If dithioesters of the same thiols are to be prepared, the molar ratio of dihalide to thiol is preferably from 1:1.8 to 3, more preferably from 1:1.8 to 2.5 and in particular about 1:2.

The simultaneous reaction with a thiol and an alcohol leads to the corresponding mono-(O)-ester monothioester.

As already detailed above, the reaction of the phosphonic dihalide with water leads to the corresponding phosphonic acid.

Polyisobutenephosphonic acids which are prepared either directly from the corresponding orthophosphonic tetrahalides or from phosphonic dihalides can in turn be derivatized. For example, they can be derivatized by reacting with alkali metal and ammonium hydroxides or carbonates, with alkaline earth metal carbonates or else with heavy metal carbonates or acetates to give the corresponding salts. The heavy metal salts, in particular the lead and silver salts, can be converted to the corresponding esters by reacting with an alkyl or aryl halide. The phosphonic esters are also obtainable by reacting the corresponding phosphonic acids with diazoalkanes. The phosphonic esters are also obtainable by reacting the phosphonic acids or their salts with dimethyl sulfate.

The phosphonic dihalides can also be converted to other phosphonic dihalides by means of halogen exchange. For example, a polyisobutenephosphonic dichloride can be converted to the corresponding phosphonic difluoride, by reacting with an alkali metal fluoride, zinc fluoride, sodium hexafluorosilicate, antimony(III) fluoride or hydrogen fluoride. When two phosphonic dihalides having different halogen atoms are reacted together, mixed phosphonic dihalides, for example, are obtained.

In a further preferred embodiment of the process according to the invention, the orthophosphonic tetrahalide obtained in the reaction of a polyisobutene with a phosphorus pentahalide is reacted with water, at least one alcohol, at least one amine and/or at least one thiol (step b2)).

Preference is given to carrying out the reaction in such a way that the reaction is not stopped at the stage of the phosphonic dihalide, but rather the derivatization products of the phosphonic dihalide which are detailed above are formed directly.

The remarks made above with regard to suitable and preferred alcohols, amines or thiols, and also with regard to suitable and preferred solvents and acid scavengers apply here correspondingly. In comparison to the derivatization reactions described above and to the reactions of the orthophosphonic tetrahalide with a halogen scavenger, the reactions in this embodiment are generally effected with a large excess of water, alcohol, amine or thiol. Moreover, more severe reaction conditions, such as higher reaction temperatures and/or longer reaction times, are generally required.

However, particular preference is given to the first embodiment, in which the orthophosphonic tetrahalide is initially reacted with a halogen scavenger (variant b1) and c1)).

The polyisobutenephosphonic acid derivatives obtainable by the process according to the invention, and also by other processes, can generally be further derivatized in a variety of ways. For example, the phosphonic acid, by reacting with a phosphorus oxide halide or with a phosphorus pentahalide, can be converted to the corresponding phosphonic dihalide which can then be further derivatized as described above. Phosphonic monoesters and phosphonic monoamides can also be converted, by reacting with a phosphorus oxide halide or with a phosphonic pentahalide, to a phosphonic halide which may likewise be further derivatized as described above. The phosphonic acid itself can also be reacted with an amine to give the phosphonic mono- or diamide. The phosphonic mono- or diamides can be converted to the phosphonic mono- or diesters by reacting with an alcohol. The phosphonic diesters can conversely be converted to the corresponding phosphonamides by reacting with an amine.

The above-described derivatizations of the orthophosphonic tetrahalides, the phosphonic dihalides and phosphonic acid itself are known per se from the prior art. They are described, for example, in Houben-Weyl, Methoden der organischen Chemie, volume XII/1, pages 338 to 619 (1963) and volume E 2, pages 300 to 418 (1982), whose content and the literature cited therein are fully incorporated herein by way of reference.

The polyisobutenephosphonic acids according to the invention are also obtainable by other processes. For instance, polyisobutenes which are terminated by an alkyl halide group can be converted, for example by reacting with a phosphorus trihalide and an aluminum trihalide which has the same halogen atom, to the polyisobutene orthophosphonic tetrahalides. These may then be further converted as described above. This procedure too is described in Houben-Weyl, Methoden der organischen Chemie, volume XII/1, pages 338 to 619 (1963) and volume E 2, pages 300 to 418 (1982), whose content and literature cited therein are fully incorporated herein by way of reference.

The present invention further provides a polyisobutenephosphonic acid-containing composition, obtainable by
a) reacting a polyisobutene with a phosphorus pentahalide and either
b1) reacting the reaction product obtained in step a) with a halogen scavenger and
c1) optionally reacting the reaction product obtained in step b1) with water, at least one alcohol, at least one thiol and/or at least one amine, or
b2) reacting the reaction product obtained in step a) with water, at least one alcohol, at least one thiol and/or at least one amine.

With regard to suitable polyisobutenes, halogen scavengers, alcohols, amines and thiols, and also to suitable and preferred embodiments of the process, the same applies as was said above.

Preference is given to using no thiols in step c1) nor in step b2), i.e. the polyisobutenephosphonic acid-containing composition according to the invention preferably contains no polyisobutenephosphonic thioesters, i.e. no polyisobutenephosphonic acids in which R¹ or R² in the radical I are SR³. The term “substantially” means that the composition according to the invention contains at most 1 000 ppm, more preferably at most 100 ppm, in particular at most 50 ppm and especially at most 5 ppm, of polyisobutenephosphonic thioester. Moreover, the composition according to the invention preferably contains no phosphonic acid in which the R³ and R⁴ radicals are C₂-C₄₀₀₀-alkyl which is interrupted by an S moiety.

The polyisobutenephosphonic acid-containing composition according to the invention more preferably has a very low sulfur content, for example a sulfur content of at most 20 mol %, preferably of at most 10 mol %, particularly preferably of at most 5 mol %, more preferably of at most 1 000 ppm, even more preferably of at most 500 ppm, in particular of at most 100 ppm, especially of at most 50 ppm, of sulfur, and more especially of at most 5 ppm. In the context of the present invention, the specification of the sulfur content does not relate to elemental sulfur, but rather quite generally to sulfur-containing compounds for which the sulfur content is calculated.

In addition to the above-described polyisobutenephosphonic acid, the polyisobutenephosphonic acid-containing composition in some cases comprises further reaction products which result from the preparative process. These include, for example, phosphonimides, esters of polyesterified polyols and many more. This composition which may in some cases consist of several components is suitable for numerous applications and does not have to be purified in a costly and inconvenient manner.

The present invention also provides a composition having a sulfur content of at most 1 000 ppm, preferably at most 50 ppm, more preferably at most 10 ppm and in particular at most 5 ppm, of sulfur, comprising at least one polyisobutenephosphonic acid according to the invention and at least one carrier.

Accordingly, the polyisobutenephosphonic acid according to the invention is selected from among those in which neither R¹ nor R² in the radical of the formula I is SR³, and also neither R³ nor R⁴ are a C₂-C₄₀₀₀-alkyl radical which is interrupted by an S moiety.

Suitable carriers are all customary inert solid support materials or liquid carrier materials for surface-active substances. Suitable solid supports are, for example, customary large surface area surface-active substances such as activated carbon, clay earth, silica gel, kieselguhr, talc, kaolin, clays or silicates. Also suitable are polymers, for example polymers of mono- and diolefins, such as polyethylene and polypropylene, polymers of aromatics, such as polystyrene, poly(p-methylstyrene) and poly(α-methylstyrene), and copolymers of these olefins and/or aromatics, and also mixtures of the aforementioned homo- and copolymers. Also suitable as carriers are mixture formers such as dispersing and suspending agents. Suitable liquid carriers are customary inert solvents, for example the aprotic solvents mentioned in connection with the process according to the invention, and also carrier oils which are defined in detail hereinbelow.

The composition according to the invention contains the polyisobutenephosphonic acid preferably in an amount of from 0.01 to 99% by weight, more preferably from 0.1 to 99% by weight, based on the total weight of the composition.

The present invention further provides the use of the polyisobutenephosphonic acid according to the invention or of the polyisobutenephosphonic acid-containing compositions according to the invention for surface modification of organic or inorganic material. The remarks made above on the polyisobutenephosphonic acid according to the invention or on the particular polyisobutenephosphonic acid-containing compositions apply here correspondingly. The selection of suitable polyisobutenephosphonic acids depends specifically on the particular use and application medium and can be determined by those skilled in the art in the individual case.

In particular, the polyisobutenephosphonic acid according to the invention or the polyisobutenephosphonic acid-containing compositions according to the invention are used as corrosion inhibitors, friction modifiers, emulsifiers, dispersants, adhesion promoters, wetting agents, wetting inhibitors, volatilizing agents or printing ink additives, and also for improving the dyeability, printability, adherability or impact strength, in particular of plastics, for example the polymers mentioned in the polymer composition according to the invention below, and also as a volatilizing agent or printing ink additive in printing processes. Especially when the polyisobutenephosphonic acid according to the invention or the polyisobutenephosphonic acid-containing compositions according to the invention are used as printing ink additives, they should serve to improve the Theological properties, for example the viscosity, of the colorant composition. In addition, they should improve the tack, the tack stability, the absorption of the ink, the water absorption and/or the impact strength of the printed substrate. In addition, optical properties, for example gloss, of the printed substrate should be improved by their use.

Suitable organic materials for the surface modification with the polyisobutenephosphonic acid according to the invention or with the polyisobutenephosphonic acid-containing compositions according to the invention are, for example, plastics, in particular the polymers mentioned for the polymer composition according to the invention which follows, especially in the form of plastic films, cellulose, for example in the form of paper or cardboard, textiles of natural or synthetic fibers, leather, wood, mineral oil products such as fuels or lubricants, and additives for such mineral oil products such as lubricity improvers and cold flow improvers. Suitable inorganic materials are, for example, inorganic pigments, metal, glass, and basic inorganic materials such as cement, plaster or calcium carbonate.

In the context of the present invention, surface modification refers to the change in the interface properties of the media admixed with the polyisobutenephosphonic acid derivatives according to the invention or the polyisobutenephoshonic acid-containing composition. In this context, interfaces (phase interfaces) are surfaces which separate two nonmiscible phases from each other (gas-liquid, gas-solid, solid-liquid, liquid-liquid, solid-solid). This includes the adhesion, tack or density action, the flexibility, scratching or breaking resistance, the wettability and the wetting ability, glide properties, frictional force, corrodibility, dyeability, printability or gas permeability, etc., of the application media. Accordingly, the polyisobutenephosphonic acid according to the invention or the polyisobutenephosphonic acid-containing compositions according to the invention are preferably used as corrosion inhibitors, friction modifiers, emulsifiers, dispersants, adhesion promoters, wetting agents, wetting inhibitors, volatilizing agents or printing ink additives. Particular preference is given to using them as detergents, dispersants and/or corrosion inhibitors, in particular in fuel and lubricant additives or in fuel and lubricant compositions. In this case, preference is given to using polyisobutenephosphonic acids in which R¹ and R² in the phosphonic acid radical of the formula I are each independently OR³, SR³ or NR³R⁴. Especially in the case of use in fuel compositions or additives, particular preference is given to using polyisobutenephosphonic acids in which R¹ and R² in the phosphonic acid radical of the formula I are each independently OR³ or NR³R⁴. Alternatively, preference is given in this case to using polyisobutenephosphonic acid-containing compositions which have a very low sulfur content, for example those having at most 1000 ppm, preferably at most 500 ppm, more preferably at most 100 ppm, in particular at most 50 ppm and especially at most 5 ppm, of sulfur. Also suitable are salts of these polyisobutenephosphonic acids. Preference is also given in accordance with the invention to using the polyisobutenephosphonic acid according to the invention or the polyisobutenephosphonic acid-containing compositions according to the invention as printing ink additives in printing processes, in particular for paper, or for improving the surface behavior of plastics, such as polypropylene, in particular the dyeing behavior.

The present invention also provides a fuel and lubricant additive comprising at least one polyisobutenephosphonic acid according to the invention or one polyisobutenephosphonic acid-containing composition according to the invention. In this case also, preferred polyisobutenephosphonic acids are those in which R¹ and R² in the phosphonic acid radical I are each independently OR³, SR³ or NR³R⁴. Fuel additives in particular more preferably contain polyisobutenephosphonic acids in which R¹ and R² in the phosphonic acid radical I are each independently OR³ or NR³R⁴. Preferred polyisobutenephosphonic acid-containing compositions are in this case those which have a very low sulfur content, for example those having at most 1000 ppm, preferably at most 500 ppm, more preferably at most 100 ppm, in particular at most 50 ppm and especially at most 5 ppm, of sulfur. The remarks made above on the polyisobutenephosphonic acids according to the invention or on the polyisobutenephosphonic acid-containing composition according to the invention apply here correspondingly.

The present invention also provides a fuel and lubricant composition comprising a majority of a hydrocarbon fuel or of a lubricant and a polyisobutenephosphonic acid according to the invention or a polyisobutenephosphonic acid-containing composition according to the invention, each of which are as defined above, and also optionally at least one further additive. The remarks made above on the polyisobutenephosphonic acid according to the invention or on the polyisobutenephosphonic acid-containing composition according to the invention apply here correspondingly.

In the context of the present invention, the term “fuel” refers not only to fuels in the actual sense but also to fuels such as heating oils. Useful fuels in the actual sense are all commercial gasoline and diesel fuels. Useful other fuels are all commercial heating oils.

Preferred polyisobutenephosphonic acids here are also those in which R¹ and R² are each independently OR³, SR³ or NR³R⁴. Fuel compositions in particular more preferably contain polyisobutenephosphonic acids in which R¹ and R² in the phosphonic acid radical I are each independently OR³ or NR³R⁴. Preferred polyisobutenephosphonic acid-containing compositions are in this case also those which have a very low sulfur content, for example those having at most 1000 ppm, preferably at most 500 ppm, more preferably at most 100 ppm, in particular at most 50 ppm and especially at most 5 ppm, of sulfur.

The fuel and lubricant compositions according to the invention preferably contain the polyisobutenephosphonic acid according to the invention in an amount of from 5 to 5000 ppm, more preferably from 10 to 1000 ppm and in particular from 20 to 500 ppm.

Finally, the present invention provides an additive concentrate comprising a polyisobutenephosphonic acid according to the invention or a polyisobutenephosphonic acid-containing composition according to the invention and at least one diluent, and also optionally at least one further additive. Here also, preferred polyisobutenephosphonic acids are those in which R¹ and R² in the phosphonic acid radical I are each independently OR³, SR³ or NR³R⁴. Fuel additive concentrates in particular more preferably contain polyisobutenephosphonic acids in which R¹ and R² in the phosphonic acid radical I are each independently OR³ or NR³R⁴. Preferred polyisobutenephosphonic acid-containing compositions are in this case those which have a very low sulfur content, for example those having at most 1000 ppm, preferably at most 500 ppm, more preferably at most 100 ppm, in particular at most 50 ppm and especially at most 5 ppm, of sulfur. The remarks made above on the polyisobutenephosphonic acid according to the invention or on the polyisobutenephosphonic acid-containing composition according to the invention apply here correspondingly. The polyisobutenephosphonic acid is present in the additive concentrate according to the invention preferably in an amount of from 0.1 to 80% by weight, more preferably from 10 to 70% by weight and in particular from 30 to 60% by weight, based on the weight of the concentrate. Suitable diluents are, for example, aliphatic and aromatic hydrocarbons, such as Solvent Naphtha. If the additive concentrates according to the invention are to be used in low-sulfur diesel or gasoline fuels, preference is given to low-sulfur hydrocarbons as diluents in the additive concentrate.

In addition to the polyisobutenephosphonic acid itself, the fuel and lubricant compositions, and also the additive concentrates, according to the invention optionally contain further customary fuel and lubricant additives, preferably the additives described below:

Examples of additives which are used in the fuel and lubricant compositions, or in the concentrates, according to the invention are further additives having detergent action or having valve seat wear-inhibiting action, each of which has at least one hydrophobic hydrocarbon radical having a number-average molecular weight (M_{N}) of from 85 to 20 000 and at least one polar moiety, selected from
(a) mono- or polyamino groups having up to 6 nitrogen atoms in which at least one nitrogen atom has basic properties,
(b) hydroxyl groups in combination with mono- or polyamino groups in which at least one nitrogen atom has basic properties,
(c) carboxyl groups or their alkali metal or alkaline earth metal salts,
(d) polyoxy-C₂-C₄-alkylene moieties which are terminated by hydroxyl groups, mono- or polyamino groups, in which at least one nitrogen atom has basic properties, or are terminated by carbamate groups,
(e) carboxylic ester groups,
(f) moieties which are derived from succinic anhydride and have hydroxyl and/or amino and/or amido and/or imido groups and
(g) moieties obtained by conventional Mannich reaction of phenolic hydroxyl groups with aldehydes and mono- or polyamines.

Examples of the above additive components having detergent action include the following:

Additives containing mono- or polyamino groups (a) are preferably polyalkenemono- or polyalkenepolyamines based on polypropene or on highly reactive (i.e. having predominantly terminal double bonds, usually in the β- and γ-positions) or conventional (i.e. having predominantly internal double bonds) polybutene or polyisobutene having an M_{N} of from 600 to 5000. Such additives based on reactive polyisobutene, which can be prepared from the polyisobutene (which may contain up to 20% by weight of n-butene units) by hydroformylation and reductive amination with ammonia, monoamines or polyamines, such as dimethylaminopropylamine, ethylenediamine, diethylenetriamine, triethylenetetramine or tetraethylenepentamine, are disclosed in particular in EP-A 244 616. When polybutene or polyisobutene having predominantly internal double bonds (usually in the β- and γ-positions) are used as starting materials in the preparation of the additives, a possible preparative route is by chlorination and subsequent amination or by oxidation of the double bond with air or ozone to give the carbonyl or carboxyl compound and subsequent amination under reductive (hydrogenating) conditions. The amines used here for the amination may be the same as those used above for the reductive amination of the hydroformylated reactive polyisobutene. Corresponding additives based on polypropene are described in particular in WO-A 94/24231.

Further preferred additives containing monoamino groups (a) are the hydrogenation products of the reaction products of polyisobutenes having an average degree of polymerization P=from 5 to 100 with nitrogen oxides or mixtures of nitrogen oxides and oxygen, as described in particular in WO-A 97/03946.

Further preferred additives containing monoamino groups (a) are the compounds obtainable from polyisobutene epoxides by reaction with amines and subsequent dehydration and reduction of the amino alcohols, as described in particular in DE-A 196 20 262.

Additives containing hydroxyl groups in combination with mono- or polyamino groups (b) are in particular reaction products of polyisobutene epoxides, obtainable from polyisobutene having preferably predominantly terminal double bonds and an M_{N} of from 600 to 5000, with ammonia or mono- or polyamines, as described in particular in EP-A 476 485.

Additives containing carboxyl groups or their alkali metal or alkaline earth metal salts (c) are preferably copolymers of C₂-C₄₀-olefins with maleic anhydride, said copolymers having a total molar mass of from 500 to 20 000, some or all of whose carboxyl groups have been converted to the alkali metal or alkaline earth metal salts and the remainder of the carboxyl groups with alcohols or amines. Such additives are disclosed in particular by EP-A 307 815. Such additives can, as described in WO-A 87/01126, advantageously be used in combination with customary fuel detergents such as poly(iso)butenamines or polyetheramines.

Additives containing polyoxy-C₂- to C₄-alkylene moieties (d) are preferably polyethers or polyetheramines which are obtainable by reaction of C₂- to C₆₀-alkanols, C₆- to C₃₀-alkanediols, mono- or di-C₂-C₃₀-alkylamines, C₁-C₃₀-alkylcyclohexanols or C₁-C₃₀-alkylphenols with from 1 to 30 mol of ethylene oxide and/or propylene oxide and/or butylene oxide per hydroxyl group or amino group and, in the case of the polyetheramines, by subsequent reductive amination with ammonia, monoamines or polyamines. Such products are described in particular in EP-A 310 875, EP-A 356 725, EP-A 700 985 and U.S. Pat. No. 4,877,416. In the case of polyethers, such products also have carrier oil properties. Typical examples of these are tridecanol butoxylates, isotridecanol butoxylates, isononylphenol butoxylates and polyisobutenol butoxylates and propoxylates and the corresponding reaction products with ammonia.

Additives containing carboxylic ester groups (e) are preferably esters of mono-, di- or tricarboxylic acids with long-chain alkanols or polyols, in particular those having a minimum viscosity of 2 mm2 at 100° C, as described in particular in DE-A 38 38 918. The mono-, di- or tricarboxylic acids used may be aliphatic or aromatic acids, and particularly suitable ester alcohols or ester polyols are long-chain representatives having, for example, 6 to 24 carbon atoms. Typical representatives of the esters are adipates, phthalates, isophthalates, terephthalates and trimellitates of isooctanol, of isononanol, of isodecanol and of isotridecanol. Such products also have carrier oil properties.

Additives containing moieties which are derived from succinic anhydride and have hydroxyl and/or amino and/or amido and/or imido groups (f) are preferably corresponding derivatives of polyisobutenylsuccinic anhydride which are obtainable by reacting conventional or reactive polyisobutene having M_{N}=from 300 to 5000 with maleic anhydride by a thermal route or via the chlorinated polyisobutene. Of particular interest in this connection are derivatives with aliphatic polyamines such as ethylenediamine, diethylenetriamine, triethylenetetramine or tetraethylenepentamine. Such gasoline fuel additives are described in particular in U.S. Pat. No. 4,849,572.

Additives containing moieties (g) obtained by conventional Mannich reaction of phenolic hydroxyl groups with aldehydes and mono- or polyamines are preferably reaction products of polyisobutene-substituted phenols with formaldehyde and primary mono- or polyamines, such as ethylenediamine, diethylenetriamine, triethylenetetramine, tetraethylenepentamine or dimethylaminopropylamine. Such “polyisobutene-Mannich bases” are described in particular in EP-A 831 141, which is fully incorporated herein by way of reference.

For more precise definition of the individual detailed fuel additives, reference is explicitly made here to the abovementioned prior art documents.

Useful solvents or diluents (when preparing additive packages and concentrates) are the diluents specified above for the concentrates according to the invention, for example aliphatic and aromatic hydrocarbons, such as Solvent Naphtha.

Further customary additive components which can be combined with the polyisobutenephosphoric acid according to the invention are, for example, customary corrosion inhibitors, for example based on ammonium salts of organic carboxylic acids (said salts tending to form films) or on heterocyclic aromatics, antioxidants or stabilizers, for example based on amines such as p-phenylenediamine, dicyclohexylamine or derivatives thereof, or on phenols such as 2,4-di-tert-butylphenol or 3,5-di-tert-butyl-4-hydroxyphenyl- propionic acid, demulsifiers, antistats, metallocenes such as ferrocene or methylcyclopentadienylmanganese tricarbonyl, lubricity additives such as certain fatty acids, alkenylsuccinic esters, bis(hydroxyalkyl)fatty amines, hydroxyacetamides or castor oil or else markers. Optionally, amines are also added to reduce the pH of the fuel.

Further customary components include carrier oils. These include, for example, mineral carrier oils (base oils), in particular those of the “solvent neutral (SN) 500 to 2000” viscosity class, synthetic carrier oils based on olefin polymers having M_{N}=from 400 to 1800, in particular based on polybutene or polyisobutene (hydrogenated or nonhydrogenated), on poly-alpha-olefins or poly(internal olefin)s and also synthetic carrier oils based on alkoxylated long-chain alcohols or phenols. Likewise suitable as further additives are polyalkene alcohol-polyetheramines, as described, for example, in DE-199 16 512.2.

The present invention further provides a polymer composition comprising a polymer and at least one polyisobutenephosphonic acid according to the invention. The remarks made above with regard to suitable and preferred polyisobutenephosphonic acids apply here correspondingly. In preferred polymer compositions, both R¹ and R² in the phosphonic acid radical I of the polyisobutenephosphonic acid are OR³ and especially OH.

Suitable polymers are, for example, polymers of mono- and diolefins and of aromatics, and also copolymers of these monomers.

Suitable polymers of mono- or diolefins are, for example, polypropylene, polyisobutene, polybutene-1, poly-4-methylpentene-1, polyisoprene or polybutadiene, and also polymers of cycloolefins, for example of cyclopentene or norbornene; and also polyethylene (which may optionally be crosslinked), for example high-density polyethylene (HDPE), high-density polyethylene having a high molecular mass (HDPE-HMW), high-density polyethylene having an ultrahigh molecular mass (HDPE-UHMW), medium-density polyethylene (MDPE), low-density polyethylene (LDPE), linear low-density polyethylene (LLDPE), branched low-density polyethylene (VLDPE).

Also suitable are mixtures of these polymers, for example mixtures of polypropylene with polyisobutene, polypropylene with polyethylene (for example PP/HDPE, PP/LDPE) and mixtures of different polyethylene types (for example LDPE/HDPE).

Also suitable are copolymers of mono- and diolefins with each other, for example ethylene-propylene copolymers, linear low-density polyethylene (LLDPE) and mixtures thereof with low-density polyethylene (LDPE), propylene-butene-1 copolymers, propylene-isobutene copolymers, ethylene-butene-1 copolymers, ethylene-hexene copolymers, ethylene-methylpentene copolymers, ethylene-heptene copolymers, ethylene-octene copolymers, propylene-butadiene copolymers, isobutene-isoprene copolymers, and also terpolymers of ethylene with propylene and a diene, such as hexadiene, dicyclopentadiene or ethylidenenorbornene; and also mixtures of such copolymers with each other and with the aforementioned polymers, for example polypropylene/ethylenepropylene copolymers.

Suitable polyaromatics are, for example, polystyrene, poly(p-methylstyrene) and poly(α-methylstyrene).

Also suitable are copolymers of styrene or α-methylstyrene with dienes, for example styrene-butadiene; mixtures having high impact strength of stryene copolymers and another polymer, for example a diene polymer or an ethylene-propylene-diene terpolymer; and also block copolymers of stryene, for example styrene-butadiene-stryene, styrene-isoprene-styrene, styrene-ethylene/butylene-styrene or styrene-ethylene/propylene-styrene.

Also suitable are graft copolymers of styrene or α-methylstyrene, for example styrene on polybutadiene or styrene on polybutadiene-styrene copolymers.

Finally, binary and polynary mixtures (polyblends) of the aforementioned homo- and copolymers are suitable.

Preference is given to polyolefins, in particular polyethylene and polypropylene and especially polypropylene.

The polymer composition according to the invention may be a particulate, linear, sheetlike or three-dimensional structure.

The term “particulate structure” includes particles having a particle diameter of from 1 nm to 10 mm which are preferably dispersible or dispersed in a medium.

“Linear structure” refers in particular to fibers, filaments, yarns, threads and the like.

“Sheetlike structures” are in particular woven fabrics, knits, felts, webs, nonwoven fabrics, films and comparable two-dimensional structures. Preference is given to films.

“Three-dimensional structures” are generally shaped bodies of highly varying dimensions.

Preferred embodiments of the polymer composition according to the invention are sheetlike structures, especially films, and shaped bodies. Particular preference is given to films, in particular polypropylene films.

The polyisobutenephosphonic acid is present in the polymer composition according to the invention in an amount of preferably from 0.01 to 99% by weight, more preferably from 0.1 to 99% by weight, based on the total weight of the polymer composition.

The polymer may be modified with the polyisobutenephosphonic acid, for example, by treating the polymer which is already in the form of a particulate, linear, sheetlike or three-dimensional structure with a solution of the polyisobutenephosphonic acid in a manner which is customary for the type of the structure, for example by flushing, dipping, spraying, padding or similar methods. However, preference is given to adding the polyisobutenephosphonic acid to the polymer which is not yet in the form of the desired structure, and only then producing the structure.

For example, the polymer is mixed as a solid or in softened form with the polyisobutenephosphonic acid, and the modified plastics material is subsequently processed by customary methods, for example to films, for example by extrusion, or to fiber materials, for example by melt-spinning methods.

The polymer composition according to the invention has in particular substantially better dyeing behavior than a corresponding polymer composition which does not contain the polyisobutenephosphonic acid according to the invention.

The present invention further provides a printing ink composition comprising at least one printing ink and at least one polyisobutenephosphonic acid according to the invention. The remarks made above with regard to suitable and preferred polyisobutenephosphonic acids apply here correspondingly. In preferred printing ink compositions, both R¹ and R² in the phosphonic acid radical I of the polyisobutenephosphonic acid are an OR³ radical where R³ is not H. In particular, R³ is a radical of the formula IV.a where 1 is a number from 1 to 4.

In this context, printing inks are solid, pasty or liquid colorant preparations which are used in printing machines. Suitable printing inks depend on the particular printing processes in which they are used, and upon the material to be printed.

The material to be printed may be either absorbent or nonabsorbent and be elongated in one dimension, for example in fiber form, in two dimensions (flat) or in three dimensions, for example cylindrically or conically. Flat materials are, for example, paper, cardboard, leather or films, for example plastics or metal films. Cylindrical or conical materials are, for example, hollow bodies, for example cans. Preferred materials are paper and plastics films. Suitable plastics are the polymers mentioned for the polymer composition according to the invention.

The printing ink composition according to the invention may be used in all common printing processes, for example relief printing such as letterpress printing and flexographic printing, planographic printing such as offset printing, lithographic printing and collotype printing, gravure printing such as rotogravure printing and steel plate printing, and also porous printing such as screenprinting, frame, film and stencil printing. Preference is given to using the printing ink composition according to the invention in offset printing.

Suitable colorants are either pigments or dyes. Suitable pigments and dyes are all colorants which are customary in the particular printing process.

The printing ink composition according to the invention generally contains a colorant composition which is customary for the particular printing process and a polyisobutenephosphonic acid according to the invention.

In addition to the colorant, colorant compositions generally comprise binders which are usually referred to as printing varnishes, and additives such as desiccants, diluents, wax dispersions and optionally catalysts or initiators for the irradiative drying. The composition is selected specifically by the printing process, the substrate to be printed and the quality desired in the printing with regard to appearance such as gloss, opacity, hue and transparency, and physical properties such as water, fat, solvent resistance, rubbing resistance and lamination capability.

For instance, varnishes for pasty offset, letterpress and screenprinting inks consist, for example, of stand oils, phenol-modified rosins, mineral oils, linseed oil and/or alkyd resins (combination varnishes) or of hydrocarbon resins and rosins, asphalt and cyclo rubber (mineral oil varnishes). Suitable varnishes for flexographic, gravure and screenprinting inks are, for example, resin-solvent systems comprising collodium wool, polyamide resins, ketone resins, vinyl polymers, maleate, phenol, amine, acrylic, polyester or polyurethane resins as binders, and a solvent such as ethanol, ethyl acetate or high-boiling alcohols, esters and glycol ethers.

The colorant composition is modified with the polyisobutenephosphonic acid, for example, by intimate mixing of these components. Alternatively, all individual components of the colorant composition may also be mixed with the polyisobutenephosphonic acid to give the printing ink composition according to the invention. However, all individual components of the colorant composition may also initially be mixed with the polyisobutenephosphonic acid and this mixture subsequently mixed with the remaining components.

The polyisobutenephosphonic acids according to the invention have outstanding long-term storage stabilities and effectiveness in surface modification, for example for hydrophobicizing organic materials such as textiles or plastics, or inorganic materials such as plaster, cement, calcium carbonate (for example in the form of mortar) or metals, as corrosion inhibitors, friction modifiers, emulsifiers or dispersants, adhesion promoters, wetting agents, wetting inhibitors, volatilizing agents or printing ink additives, and also for improving the dyeability of organic materials, in particular plastics, and for improving the Theological and printing properties of printed material, in particular paper. For use in fuel and lubricant compositions, low-sulfur or sulfur-free polyisobutenephosphonic acids or polyisobutenephosphonic acid-containing compositions in particular are preferred.

The examples which follow are intended to illustrate the invention, but without limiting it.

### EXAMPLES

### 1. Preparation of polyisobutenephosphonic dichlorides

### 1.1. Conversion of a polyisobutene having Mₙ=1000 to the corresponding phosphonic dichloride

A 500 ml four-neck flask was initially charged with 100 g of a polyisobutene (Mₙ=1000; PDI=1.65; 85% α-olefin content) and 100 ml of hexane at room temperature, and heated to 50° C. At the same temperature, 41.65 g of phosphorus pentachloride were added to this solution and the mixture was stirred for a further 2 hours, in the course of which hydrogen chloride formed and the viscosity increased gradually. Subsequently, 21.01 g of acetic anhydride were added to the reaction mixture at the same temperature, and the viscosity decreased again. After stirring for a further 30 minutes, hexane, and acetyl chloride and phosphorus oxychloride which had formed, were removed on a rotary evaporator at 100° C, and 5 mbar. 106.9 g of the corresponding polyisobutenephosphonic dichloride were obtained as a viscous yellowish oil.

IR (film on KBr) [cm⁻¹]: 2951, 2896, 1609 (C═C), 1472, 1389, 1366, 1231, 1227 (P═O), 550 (P—Cl).

The vibration at 891 cm⁻¹ which is characteristic of a free α-olefin is absent.

### 1.2 Preparation of 2,4,4,6,6-pentamethylhept-1-enephosphonic dichloride

A 500 ml four-neck flask was initially charged with 84 g of 2,4,4,6,6-pentamethylhept-1-ene (trimeric isobutene) and 200 ml of hexane at room temperature, and admixed in portions with 208.2 g of phosphorus pentachloride. Subsequently, the mixture was heated slowly to 50° C., in the course of which hydrogen chloride formed and the viscosity simultaneously increased. After 2 hours, 103.6 g of acetic anhydride were added dropwise at 50° C., and the viscosity decreased again. After stirring for 15 minutes, hexane, and acetyl chloride and phosphorus oxychloride which had formed, were removed on a rotary evaporator at 70° C. and 5 mbar. 142 g of 2,4,4,6,6-pentamethylhept-1-enephosphonic dichloride were obtained as a viscous yellowish oil.

¹H NMR (CDCl₃, 400 MHz): 5.89 (s, 1H), 5.80 (s, 1H), 2.29 (dd, J=1.2 and 5.0 Hz, 3H), 2.23 (d, J=2.9 Hz, 2H), 1.32 (s, 2H), 1.06 (s, 6H), 1.00 (s, 9 H).

s=singlet

d=doublet

dd=doublet of doublets

### 1.3. Conversion of a polyisobutene having Mₙ=550 to the corresponding phosphonic dichloride

In a 4 1 four-neck flask, 833 g of phosphorus pentachloride were suspended in 300 ml of hexane. A solution of 1100 g of a polyisobutene (Mₙ=550; PDI=1.65; 85% α-olefin content) in 400 ml hexane was added dropwise to the suspension within one hour with stirring and cooling in such a way that the temperature in the interior of the flask did not exceed room temperature. Subsequently, the reaction mixture was heated to 40° C. and stirred at this temperature for a further 30 minutes. 408.5 g of acetic anhydride were then added to the reaction mixture at the same temperature and it was stirred at this temperature for a further hour. Finally, hexane, and acetyl chloride and phosphorus oxychloride which had formed, were removed on a rotary evaporator at 100° C. and 5 mbar. 1106.4 g of the corresponding polyisobutenephosphonic dichloride were obtained as a viscous yellowish oil.

IR (film on KBr) [cm⁻¹]: 2951, 2896, 1610 (C═C), 1473, 1389, 1366, 1231, 1227 (P′O), 553 (P—Cl).

The vibration at 891 cm⁻¹ which is characteristic of a free α-olefin is absent.

### 2. Derivatization of polyisobutenephosphonic dichlorides

### 2.1 Preparation of a polyisobutenephosphonic acid

In a 1 l three-neck flask, a solution of 630 g of the polyisobutenephosphonic dichloride from example 1.3 in 350 ml THF was added dropwise at 0° C. within 45 minutes to a solution of 72 ml of water in 200 ml of tetrahydrofuran (THF). The mixture was allowed to thaw to room temperature and stirred for a further 3 hours. Subsequently, the solvent was removed completely under reduced pressure, the residue was taken up in 250 ml of toluene and the azeotrope was distilled at 40° C. under reduced pressure. The residue was dried over sodium sulfate and filtered, the filtercake was washed and the filtrate was completely freed of solvent at 50° C. and 2 mbar. 589.3 g of the corresponding polyisobutenephosphonic acid were obtained as a viscous, yellowish oil.

IR (film on KBr) [cm⁻¹]: 2952, 2895, 2328 (P(O)—OH), 1626 (C═C), 1473, 1389, 1366, 1231, 1181 (P═O).

The P—Cl vibration at 550 cm⁻¹ was absent.

### 2.2 Preparation of a polyisobutenephosphonic monoester from triethylene glycol monomethyl ether

A 500 ml four-neck flask equipped with stirrer, dropping funnel and reflux condenser was initially charged with 133.4 g of the polyisobutenephosphonic dichloride from example 1.3 in 100 ml of methylene chloride at 5° C., and a solution of 32.8 g of triethylene glycol monomethyl ether in 50 ml of methylene chloride was added dropwise within 15 minutes. The reaction mixture was allowed to warm to room temperature and stirred overnight at 30° C. Subsequently, the solvent was removed under reduced pressure and the residue taken up in 100 ml of THF. A solution of 9 ml of water in 30 ml of THF was added to this mixture at room temperature, and the mixture was stirred for 2 hours and finally concentrated fully at 80° C. and 2 mbar. 145.6 g of the corresponding polyisobutenephosphonic monoester of triethylene glycol monomethyl ether were obtained as a viscous, brown oil.

IR (film on KBr) [cm⁻¹]: 2951, 2894, 2320 (P(O)—OH), 1625 (C═C), 1471, 1389, 1366, 1231, 1201 (P═O), 1139 (P—O-alkyl), 1113 (P—O-alkyl).

The P—Cl vibration at 550 cm⁻¹ was absent.

### 2.3 Preparation of a polyisobutenephosphonic diester of triethylene glycol monomethyl ether

A 1 l four-neck flask was initially charged with 65.7 g of triethylene glycol monomethyl ether and 31.6 g of anhydrous pyridine in 150 ml of toluene at 5° C. and a solution of 133.4 g of the polyisobutenephosphonic dichloride from example 1.3 in 100 ml of toluene was added dropwise within 30 minutes. The reaction mixture was allowed to warm to room temperature and was stirred at 40° C. overnight. The precipitated pyridinium chloride was then filtered off and the solvent was removed on a rotary evaporator at 80° C. and 2 mbar. 187.9 g of the corresponding polyisobutenephosphonic diester of triethylene glycol monomethyl ether were obtained as a viscous, brown oil.

IR (film on KBr) [cm⁻¹]: 2951, 2892, 1623 (C═C), 1471, 1389, 1366, 1233, 1200 (P═O), 1135 (P—O-alkyl), 1111 (P—O-alkyl).

The P—Cl vibration at 550 cm⁻¹ was absent.

### 2.4 Preparation of a polyisobutenephosphonic diamide of tetraethylenepentamine

A 2 l four-neck flask was initially charged with 113.6 ml of freshly distilled tetraethylenepentamine in 200 ml of hexane at 40° C. and a solution of 200 g of the polyisobutenephosphonic dichloride from example 1.3 in 300 ml of hexane was added dropwise within 45 minutes. Subsequently, the reaction mixture was heated to reflux for 5 hours, cooled to room temperature and left to stir further overnight. Subsequently, the solvent was removed on a rotary evaporator at 100° C. and 2 mbar. 330.1 g of the corresponding polyisobutenephosphonic diamide of tetraethylenepentamine were obtained as a viscous, yellow, cloudy oil.

### 3. Application Examples

### 3.1. Improvement in the Dyeability of Polypropylene

The dyeability of polypropylene additized with polyisobutenephosphonic acid according to the invention with a cationic dye was investigated. The polypropylene used was Metocene® X 50248 from Basell, a homopropylene prepared under metallocene catalysis.

The polyisobutenephosphonic acid according to the invention used was firstly the polyisobutenephosphonic acid from example 1.3 (A) and secondly a polyisobutenephosphonic acid based on Glissopal 1000 (B) (R¹, R²═OH).

The experiments were carried out in a double-screw extruder at a casing temperature of 180° C. and 200 rpm. The nozzle output was 1×4 mm. The throughput was 5 kg/h, and the polyisobutenephosphonic acids A or B were added at a throughput of 250 g/h. The metering pump was operated at from 100 to 200 g/h. In each case 5% by weight of the polyisobutenephosphonic acids A or B was added to the polypropylene granules.

These granules which were obtained after the extrusion were pressed to plates (approx. 160×160×2 mm; weight approx. 46 g; pressing time 4 minutes at 220° C., in each case 1 min at 50, 100, 150 and 200 bar). In addition, corresponding sample plates were produced from nonadditized polypropylene granules. The plates obtained were used to carry out dyeing experiments.

The dye used was the cationic dye Basacryl Rot X-BL 300%. The sample plates were dyed with the addition of 1.1% dye in demineralized and buffered water at pH 6 in a liquor ratio of 1:50 by heating in an AHIBA dyeing apparatus from 110° C. to 130° C. within 20 min, and leaving at this temperature for 2 h. Subsequently, they were cooled to 800C, the sample plates were withdrawn, flushed with cold water and dried at 100° C. Subsequently, the color depth achieved was assessed by customary methods. The following results were obtained:
unadditized polypropylene: substantially no dyeing: 1/24 SD*
polypropylene additized with A: ⅓ SD*
polypropylene additized with B: ⅓ SD*
*SD=Standard Depth

### 3.2. Use of a polyisobutenephosphonic acid according to the invention in a heatset roll offset printing process

The printing machine used was a “MAN Roland” RZK III.

The paper used was two different coated art printing papers from Zanders having the names Mega Gloss and LWC.

The polyisobutenephosphonic acid used was polyisobutenephosphonic (triethylene glycol monomethyl ether)diester C based on Glissopal 550 in an amount of 1% by weight, based on the total weight of the dyeing composition.

The properties investigated were rheological changes such as tack and viscosity, and also absorption behavior, rubbing resistance and gloss of the dyed paper. It was also investigated whether the printing properties of the printing machine were changed when the polyisobutenephosphonic acid according to the invention was added.

The experimental ink used was a commercial printing ink having the name Webking® 3020 Magenta from BASF-AG which contains, in addition to the colorant, customary auxiliaries such as varnishes.

After the printed paper had been dried, the viscosity, tack, tack stability, ink absorption, water absorption and delta torque (measure of the water absorption of the ink in ml before it coagulates) were investigated, firstly on paper which had been printed with a colorant composition which did not contain the polyisobutenephosphonic ester C according to the invention, and secondly with a colorant composition which had been additized in accordance with the invention of the printed paper. The results are listed in table 1.

TABLE 1

| Properties | Nonadditized | Additized |
|---|---|---|
| Ink absorption | 2% | 1.5% |
| Viscosity [Pas]: after 0 h | 35 | 31 |
| Viscosity [Pas]: after 24 h | 63 | 54 |
| Tack | 148 | 160 |
| Tack stability | 9 min | 10 min |
| Water absorption | 70% | 59% |
| Delta torque [ml] | 185 | 22 |

Viscosity, tack, tack stability, water absorption and delta torque were determined by customary processes which are known to those skilled in the art. The intended viscosity was from 35 to 42 Pas. The intended tack was from 145 to 175. As table 1 shows, papers which have been printed with an ink which has been additized with the polyisobutenephosphonic ester C according to the invention have a lower water absorption of the ink and a smaller increase in the viscosity after 24 h.

In addition, the gloss of the printed paper was assessed. The results are listed in table 2.

TABLE 2

| Paper | Property | Nonadditized | Additized |
|---|---|---|---|
| Mega Gloss | Density [g/cm³] | 1.67 | 1.61 |
| | Gloss (print direction) | 47.6 | 49.1 |
| | Gloss (transverse) | 54.1 | 53.9 |
| | Gloss (preprint; print direction) | 53.9 | 54.2 |
| | Gloss (preprint; transverse) | 66.7 | 67.9 |
| LWC | Density [g/cm³] | 1.66 | 1.62 |
| | Gloss (print direction) | 29.7 | 31.2 |
| | Gloss (transverse) | 35.9 | 37.8 |

Density and gloss were determined by customary processes which are known to those skilled in the art.

As table 2 shows, papers which have been printed with an ink 20 which contains the polyisobutenephosphonic ester C according to the invention, despite having a lower density, have a distinct rise in gloss compared to the nonadditized ink.

In addition, the ink additized with the polyisobutenephosphonic ester according to the invention has more favorable absorption behavior than a nonadditized ink.

The ink additized in accordance with the invention also has no printing disadvantages.

### 3.3. Hydrophobicization of a Metal Surface (Aluminum Sheet)

A 0.2% solution of a polyisobutylphosphonic acid was prepared by mixing 898 parts by weight of distilled water, 100 parts of Emulan® HE 50 (nonionic emulsifier, BASF Aktienges., Ludwigshafen) and two parts of polyisobutylphosphonic acid from example 2.1.

An aluminum sheet was immersed into this solution for 17 h and rinsed with a large amount of water. The comparison used was an aluminum sheet which was immersed into a solution of 100 parts of Emulan® HE 50 in 900 parts by weight of distilled water for 17 h.

The water drops on the sheet surface exhibited the following contact angle:

| | |
|---|---|
| Inventive: | 104° |
| Comparative: | 65° |

### 3.4 Corrosion Protection

For the sheets prepared according to 3.3, the fundamental electrochemical parameters determined were the breakdown potential (in 0.6 mol/l NaCl and sat. Ca(OH)₂), the corrosion current and the polarization resistance.

| | |
|---|---|
| Comparative | Treated |

| | | | | |
|---|---|---|---|---|
| Breakdown potential | −550 | mV | −380 | mV |
| Corrosion current | 2700 | μA/cm² | 1000 | μA/cm² |
| Polarization resistance | 50 | kΩ | 150 | kΩ |

The values demonstrate a significant reduction in corrosion in the case of the sheet treated in accordance with the invention.

1. A process for preparing a polyisobutenephosphonic acid, comprising a phosphonic acid radical of the general formula I 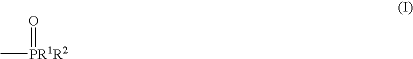
wherein
R¹ and R² are each independently halogen, OR³, SR³ or NR³R⁴;
R³ and R⁴ are each independently H, C₁-C₂₀-alkyl or C₂-C₄₀₀₀-alkyl which is interrupted by at least one moiety which is selected from the group consisting of O and NR¹¹, and R³ and R⁴ together with the nitrogen atom to which they are bonded may also form a ring, and R³ and R⁴ are also aryl, aralkyl or cycloalkyl; and
R¹¹ is as defined for R³ and R⁴,
and salts thereof, comprising
a) reacting a polyisobutene with a phosphorus pentahalide and either
b1) reacting the reaction product obtained in step a) with a halogen scavenger and
c1) optionally reacting the reaction product obtained in step b1) with water, at least one alcohol, at least one thiol and/or at least one amine, or
b2) reacting the reaction product obtained in step a) with water, at least one alcohol, at least one thiol and/or at least one amine.

2. The process as claimed in claim 1, comprising using a thiol neither in step c1) nor in step b2).

3. The process of claim 1, wherein the halogen scavenger is selected from the group consisting of water, alcohols, carboxylic acids, carboxylic anhydrides, phosphonic acids, phosphorus pentoxide and sulfur dioxide.

4. The process of claim 1, wherein the polyisobutenephosphonic acid comprises at least one phosphonic acid radical of the formula I which is disposed at at least one of the chain ends of the polyisobutene.

5. The process of claim 1, wherein the polyisobutene radical has a number average molecular weight Mₙ of from 100 to 100,000 daltons.

6. A polyisobutenephosphonic acid-containing composition, obtained by
a) reacting a reactive polyisobutene with a phosphorus pentahalide and either
b1) reacting the reaction product obtained in step a) with a halogen scavenger and
c1) optionally reacting the reaction product obtained in step b1) with water, at least one alcohol and/or at least one amine, or
b2) reacting the reaction product obtained in step a) with water, at least one alcohol and/or at least one amine.

7. A composition comprising a sulfur content of at most 1,000 ppm, comprising a polyisobutenephosphonic acid, comprising a phosphonic acid radical of the general formula I 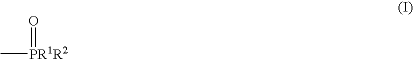
wherein
R¹ and R² are each independently halogen, OR³ or NR³R⁴;
R³ and R⁴ are each independently H, C₁-C₂₀-alkyl or C₂-C₄₀₀₀-alkyl which is interrupted by at least one moiety which is selected from the group consisting of O and NR¹¹, and R³ and R⁴ together with the nitrogen atom to which they are bonded may also form a ring, and R³ and R⁴ are also aryl, aralkyl or cycloalkyl; and
R¹¹ is as defined for R³ and R⁴,
wherein the phosphonic acid radical of the general formula I is bonded to a carbon atom of a polyisobutene group which is part of a carbon-carbon double bond,
or salts thereof,
and at least one inert solid support material or liquid carrier material.

8. A composition comprising a sulfur content of at most 1,000 ppm, comprising a polyisobutenephosphonic acid, comprising a phosphonic acid radical of the general formula I 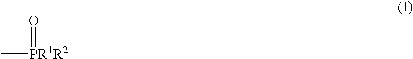
wherein
R¹ and R² are each independently halogen, OH, NH₂, OR³, wherein R³ is C₁-C₂₀-alkyl, NR³R⁴, wherein R³ is H or C₁-C₂₀-alkyl and R⁴ is C₁-C₂₀-alkyl, or a radic of the formula V.a or V.b
—O [symbol] (CH₂)₂—O [symbol] ₗ—(CH₂)₂—OR¹² (V.a)
—NH [symbol] (CH₂)₂—NH [symbol] ₗ—(CH₂)₂—NR¹²R¹³ (V.b)
wherein
R¹² and R¹³ are each independently H or C₁-C₆-alkyl; and
l is a number of from 1 to 1,000,
or salts thereof,
and at least one inert solid support material or liquid carrier material.

9. The composition as claimed in claim 7 comprising a sulfur content of at most 50 ppm.

10. The composition as claimed in claim 6, wherein the polyisobutenephosphonic acid comprises at least one phosphonic acid radical of the formula I which is disposed at at least one of the chain ends of the polyisobutene.

11. The composition of claim 6, wherein the polyisobutene radical has a number-average molecular weight Mₙ of from 100 to 100,000 daltons.

12. An organic or inorganic material comprising, on the surface thereof, the polyisobutenephosphonic acid of claim 6.

13. (canceled)

14. A printing ink composition, comprising at least one printing ink and at least one polyisobutenephosphonic acid as defined in claim 1.

15. A polymer composition, comprising a polymer and at least one polyisobutenephosphonic acid as defined in claim 1.
